(19) United States
(12) Patent Application Publication
(10) Pub. No.: US 2022/0318277 A1
(43) Pub. Date: Oct. 6, 2022

(54) INFORMATION PROCESSING DEVICE, INFORMATION PROCESSING METHOD, AND STORAGE MEDIUM

(71) Applicant: NEC Corporation, Minato-ku, Tokyo (JP)

(72) Inventors: Takashi KONASHI, Tokyo (JP); Satoru YAMANO, Tokyo (JP); Shohei MITANI, Tokyo (JP)

(73) Assignee: NEC Corporation, Minato-ku, Tokyo (JP)

(21) Appl. No.: 17/635,568

(22) PCT Filed: Aug. 22, 2019
(86) PCT No.: PCT/JP2019/032725

§ 371 Date: Feb. 15, 2022

(51) Int. Cl. G06F 16/28; G06F 16/22; G07C 5/08

(52) U.S. Cl. CPC G06F 16/288; G06F 16/22; G07C 5/08

(57) ABSTRACT

An information processing device according to an aspect of the present disclosure includes: at least one memory; and at least one processor configured to execute instructions to: acquire a plurality of parameters indicating a state of a device; and extract a combination including two or more parameters from the plurality of parameters based on a dependency relationship between two parameters among the plurality of parameters.

### TECHNICAL FIELD

The present disclosure relates to a technique for processing information, and more particularly, to a technique for processing information indicating a state of a device.

### BACKGROUND ART

There is a method of detecting an abnormality in a controller area network (CAN). The method uses a plurality of signals with values embedded in a data field of a CAN frame (hereinafter, also referred to as a frame), and utilizes a relationship existing between the plurality of signals. The method is described in PTL 1, for example.

The abnormality detection method disclosed in PTL 1 detects an abnormality when values of signals defined in two different types of frames do not satisfy a condition applied to each of the values of the signals.

### CITATION LIST

### Patent Literature

[PTL 1] WO 2017/119027 A

### SUMMARY OF INVENTION

### Technical Problem

PTL 1 does not disclose a process for selecting signals defined in different types of frames. Therefore, there is a problem that a combination of signals to which the condition is applied is not necessarily selected as a combination of signals suitable for detecting an abnormality (for example, a combination of relevant signals). Incidentally, in the following description, a signal is also referred to as a parameter. In other words, even when an abnormality is detected with a combination of parameters which are irrelevant to each other, the combination does not conform to the conditions applied to the parameters. As a result, there is a problem that an abnormality cannot be detected.

An object of the present disclosure is to provide an information processing device or the like capable of extracting a relevant parameter.

### Solution to Problem

An information processing device according to one aspect of the present disclosure includes: an acquiring means configured to acquire a plurality of parameters indicating a state of a device; and an extracting means configured to extract a combination including two or more parameters from the plurality of parameters based on a dependency relationship between two parameters among the plurality of parameters.

An information processing method according to one aspect of the present disclosure includes: acquiring a plurality of parameters indicating a state of a device; and extracting a combination including two or more parameters from the plurality of parameters based on a dependency relationship between two parameters among the plurality of parameters.

A storage medium according to one aspect of the present disclosure stores a program for causing a computer to execute: an acquisition process of acquiring a plurality of parameters indicating a state of a device; and an extraction process of extracting a combination including two or more parameters from the plurality of parameters based on a dependency relationship between two parameters among the plurality of parameters. One aspect of the present disclosure is also achieved by a program stored in the above-described storage medium.

### Advantageous Effects of Invention

The present disclosure has an effect that a relevant parameter can be extracted.

### BRIEF DESCRIPTION OF DRAWINGS

FIG. 1 is a block diagram illustrating an example of an operation environment of an information processing device according to a first example embodiment of the present disclosure.

FIG. 2 is a block diagram illustrating a second example of the operation environment of the information processing device according to the first example embodiment of the present disclosure.

FIG. 3 is a block diagram illustrating a third example of the operation environment of the information processing device according to the first example embodiment of the present disclosure.

FIG. 4 is a block diagram illustrating an example of a configuration of the information processing device according to the first example embodiment of the present disclosure.

FIG. 5 is a diagram illustrating an example of a dependency relationship between parameters.

FIG. 6 is a first diagram schematically illustrating an example of the dependency relationship between parameters.

FIG. 7 is a second diagram schematically illustrating the example of the dependency relationship between parameters.

FIG. 8 is a diagram schematically illustrating an example of an extracted closed combination.

FIG. 9 is a flowchart illustrating an example of an operation of acquiring a data frame by the information processing device according to the first example embodiment of the present disclosure.

FIG. 10 is a flowchart illustrating an example of an operation of extracting a combination of parameters by the information processing device according to the first example embodiment of the present disclosure.

FIG. 11 is a flowchart illustrating an example of the operation of extracting a combination of parameters by the information processing device according to the first example embodiment of the present disclosure.

FIG. 12 is a flowchart illustrating an example of an operation of a combination extraction process of the information processing device according to the first example embodiment of the present disclosure.

FIG. 13 is a flowchart illustrating an example of an operation of a separation process of the information processing device according to the first example embodiment of the present disclosure.

FIG. 14 is a flowchart illustrating an example of an operation of a combination candidate update process of the information processing device according to the first example embodiment of the present disclosure.

FIG. 15 is a flowchart illustrating still another example of the operation of extracting the combination of parameters by the information processing device according to the first example embodiment of the present disclosure.

FIG. 16 is a block diagram illustrating an example of a configuration of an information processing device according to a first modification of the first example embodiment of the present disclosure.

FIG. 17A is a block diagram illustrating a first example of a configuration of an information processing device according to a second modification of the first example embodiment of the present disclosure.

FIG. 17B is a block diagram illustrating a second example of the configuration of the information processing device according to the second modification of the first example embodiment of the present disclosure.

FIG. 17C is a block diagram illustrating a third example of the configuration of the information processing device according to the second modification of the first example embodiment of the present disclosure.

FIG. 17D is a block diagram illustrating a fourth example of the configuration of the information processing device according to the second modification of the first example embodiment of the present disclosure.

FIG. 18A is a block diagram illustrating a first example of a configuration of an information processing device according to a third modification of the first example embodiment of the present disclosure.

FIG. 18B is a block diagram illustrating a second example of the configuration of the information processing device according to the third modification of the first example embodiment of the present disclosure.

FIG. 18C is a block diagram illustrating a third example of the configuration of the information processing device according to the third modification of the first example embodiment of the present disclosure.

FIG. 18D is a block diagram illustrating a fourth example of the configuration of the information processing device according to the third modification of the first example embodiment of the present disclosure.

FIG. 18E is a block diagram illustrating a fifth example of the configuration of the information processing device according to the third modification of the first example embodiment of the present disclosure.

FIG. 18F is a block diagram illustrating a sixth example of the configuration of the information processing device according to the third modification of the first example embodiment of the present disclosure.

FIG. 19A is a block diagram illustrating a first example of a configuration of an information processing device according to a fourth modification of the first example embodiment of the present disclosure.

FIG. 19B is a block diagram illustrating a second example of the configuration of the information processing device according to the fourth modification of the first example embodiment of the present disclosure.

FIG. 19C is a block diagram illustrating a third example of the configuration of the information processing device according to the fourth modification of the first example embodiment of the present disclosure.

FIG. 19D is a block diagram illustrating a fourth example of the configuration of the information processing device according to the fourth modification of the first example embodiment of the present disclosure.

FIG. 20 is a block diagram illustrating an example of a configuration of an information processing device according to a fifth modification of the first example embodiment of the present disclosure.

FIG. 21 is a block diagram illustrating an example of a configuration of an information processing device according to a second example embodiment of the present disclosure.

FIG. 22 is a flowchart illustrating an example of an operation of the information processing device according to the second example embodiment of the present disclosure.

FIG. 23 is a block diagram illustrating an example of a hardware configuration of a computer which can achieve the information processing device according to the example embodiment of the disclosure.

FIG. 24A is a block diagram illustrating an example of a configuration of an information processing system according to sixth to eleventh modifications and thirteenth to fifteenth modifications of the first example embodiment of the present disclosure.

FIG. 24B is a block diagram illustrating an example of a configuration of an information processing system of sixth to fifteenth modifications of the first example embodiment of the present disclosure.

### EXAMPLE EMBODIMENT

Next, example embodiments of the present disclosure will be described in detail with reference to the drawings.

### First Example Embodiment

First, a first example embodiment of the present disclosure will be described. The first example embodiment is an example of a case where the device described below is a vehicle.

«Configuration»

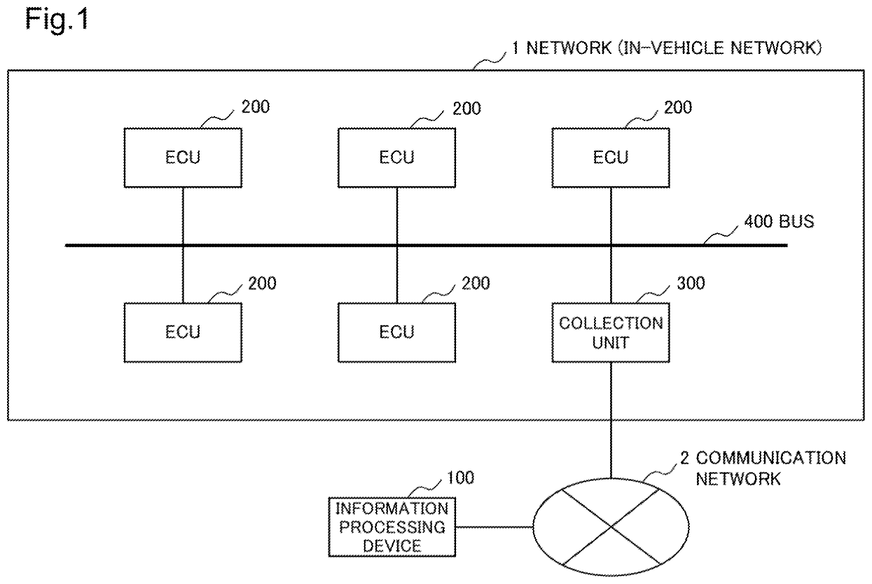

FIG. 1 is a block diagram illustrating an example of an operation environment of an information processing device 100 according to the present example embodiment. In the example illustrated in FIG. 1, the information processing device 100 is connected to a collection unit 300 in a network 1 via a communication network 2. The network 1 is a communication network mounted on the device. Then, a packet (also referred to as a data frame) including a value of a signal generated in the device is transmitted to the network 1. The data frame includes a plurality of parameter values corresponding to values of a plurality of signals indicating a state of the device. The device is, for example, a vehicle such as an automobile. The device may be a control device, a plant, or the like.

In the present example embodiment, the device is described as a vehicle. However, in the drawings referred to in the description, the vehicle is described as a “device”. In the present example embodiment, the network 1 is an in-vehicle network. The network 1 may be a network other than the in-vehicle network. Hereinafter, in the description of the present example embodiment, the network 1 is referred to as an in-vehicle network 1.

The in-vehicle network 1 is, for example, a communication network mounted on a vehicle such as an automobile. The in-vehicle network 1 may be a network generally called CAN. The in-vehicle network 1 is achieved by, for example, a bus 400 to which a plurality of electronic control units (ECUs) 200 are connected. The ECU 200 is, for example, a controller attached to components such as an engine, an accelerator, a steering, an air conditioner, and a transmission. The component to which the ECU 200 is attached is not limited to these examples. The ECU 200 is used to control the component attached with the ECU.

For example, the ECU 200 acquires, from the component attached with the ECU 200, information detected by a sensor or the like of the component. The information acquired from the component is, for example, a state of the component, a state related to the entire vehicle including the component, or a state related to a part of the vehicle. The state related to the entire vehicle is, for example, a speed, an acceleration, and an outside temperature. The state related to a part of the vehicle is, for example, a room temperature. The ECU 200 generates a data frame including the information acquired from the component attached with the ECU 200 as a parameter value. ECU 200 transmits the generated data frame to the bus 400. The ECU 200 may read a necessary data frame among the data frames flowing through the bus 400, and use the read data frame to control the component attached with the ECU 200.

The parameter is, for example, a speed, an acceleration, an accelerator opening degree, a steering wheel steering angle, a yaw rate, a shift position, a brake pressure, or the like. The parameter is not limited to the above examples. The parameter included in the data frame transmitted by the ECU 200 may be determined according to the component attached with the ECU 200. The plurality of ECUs 200 transmits data frames at respective timings. In other words, the timings at which the plurality of ECUs 200 transmits the data frames may not necessarily be regular.

In the present example embodiment, the state of the vehicle indicates, for example, a set of the above-described states acquired from a plurality of predetermined components. In other words, the state of the vehicle is indicated by the parameter value included in the data frame transmitted from the ECU 200 in the component included in the vehicle. Therefore, the information processing device 100 of the present example embodiment handles a set of parameter values obtained from the plurality of predetermined ECUs 200, that is, a set of predetermined parameter values, as the state of the vehicle.

In the present example embodiment, it is considered that the parameter value included in the data frame most recently transmitted by the ECU 200 indicates the above-described state acquired from the component. When the state acquired from the component changes, the change in the state appears as a change in the parameter value included in the data frame transmitted by the ECU 200 attached to the component. That is, the parameter value included in the data frame transmitted by the ECU 200 attached to the component changes from the parameter value included in the data frame previously transmitted by the ECU 200. In the following description, the state of the vehicle is referred to as “the state of the device”. The state of the device indicates a combination of a plurality of parameter values.

Next, the collection unit 300 will be described in detail. The collection unit 300 is attached to the bus 400 of the in-vehicle network 1. The collection unit 300 collects a data frame which is transmitted by the ECU 200 to flow through the bus 400 and includes at least one parameter value. The collection of the data frames by the collection unit 300 is performed while the vehicle on which the in-vehicle network 1 is mounted normally travels. The vehicle from which the collection unit 300 collects the data frame is, for example, a vehicle which is confirmed to operate normally and that the unauthorized ECU 200 is not connected to the in-vehicle network 1. The data frames collected by the collection unit 300 may be collected in the vehicle that actually travels as described above. The data frame collected by the collection unit 300 may be generated by simulation. In that case, the collection unit 300 may be achieved by a computer which performs vehicle simulation. The collection unit 300 may be connected to the computer which performs the vehicle simulation, and may receive the data frame from the computer. The collection unit 300 may receive the parameter value itself instead of the data frame.

The collection unit 300 associates the collected data frames with information (hereinafter, also referred to as order information) that can specify the order in which the data frames are collected. The information that can specify the order in which the data frames are collected may be, for example, a serial number indicating the order in which the data frames are collected. The serial number in this case may be a serial number after the collection unit 300 starts the operation (that is, after the power of the collection unit 300 is turned on). The information that can specify the order in which the data frames are collected may be, for example, data indicating the date and time when the data frames are collected. The information that can specify the order in which the data frames are collected may be, for example, information indicating the time (hereinafter, also referred to as an elapsed time) that has elapsed since the start of the operation of the collection unit 300. The information that can specify the order in which the data frames are collected may be, for example, information indicating an elapsed time from an appropriately determined time. The information that can specify the order in which the data frames are collected is not limited to the above example.

In the description of the present example embodiment, information indicating the data frame itself and information which is associated with the data frame and can specify the order in which the data frames are collected are collectively referred to as information of the data frame.

The collection unit 300 may collect a plurality of sets of data frames from one vehicle. The set of data frames refers to a collection of data frames collected from one vehicle continuously over a period of time. The period in which the data frame is collected may not be the same for different sets. The collection unit 300 may collect data frames from a plurality of vehicles of the same type. The collection unit 300 may collect data frames from a plurality of vehicles of different types. The type of vehicle may refer to a set of vehicles having the same model number. The type of vehicle may refer to a set of vehicles in which at least some of the parts used are identical. The type of vehicle may refer to a set of vehicles of the same model number which are manufactured in the same place, period, or both. The type of the vehicle may refer to a category of the vehicle appropriately defined as described above. The information that can specify the order in which the data frames are collected may be information that can specify the order in which the data frames are collected in a set including the data frames. The following mainly describes a case where a data frame is included in one set of data frames collected from one vehicle.

The collection unit 300 may store information of the collected data frame. The collection unit 300 transmits the information of the collected data frame to the information processing device 100, for example, via the communication network 2. The information processing device 100 may receive information of the collected data frame transmitted by the collection unit 300.

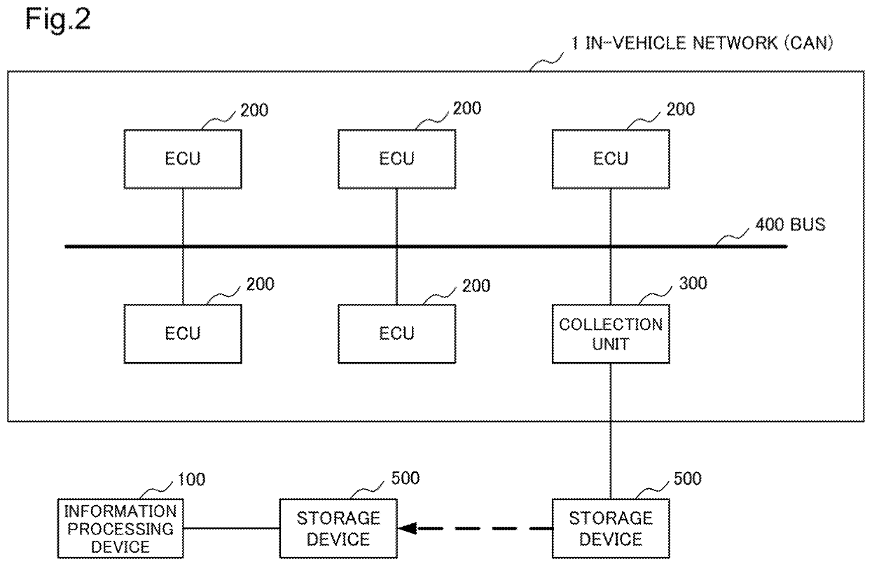

FIG. 2 is a block diagram illustrating a second example of the operation environment of the information processing device 100 according to the present example embodiment. The ECU 200 and the bus 400 illustrated in FIG. 2 are the same as the ECU 200 and the bus 400 illustrated in FIG. 1. The collection unit 300 illustrated in FIG. 2 is attached to the bus 400 of the in-vehicle network 1 similarly to the collection unit 300 illustrated in FIG. 1. Similarly to the collection unit 300 illustrated in FIG. 1, the collection unit 300 illustrated in FIG. 2 collects the data frames transmitted by the ECU 200 and flowing through the bus 400.

In the example illustrated in FIG. 2, a storage device 500 is connected to the collection unit 300. The collection unit 300 stores the information of the collected data frame in the storage device 500. The storage device 500 may be detachable. For example, an administrator of the information processing device 100 may detach the storage device 500 connected to the collection unit 300 from the collection unit 300 and connect the detached storage device 500 to the information processing device 100.

The information processing device 100 may read the information of the data frame from the storage device 500 connected to the information processing device 100.

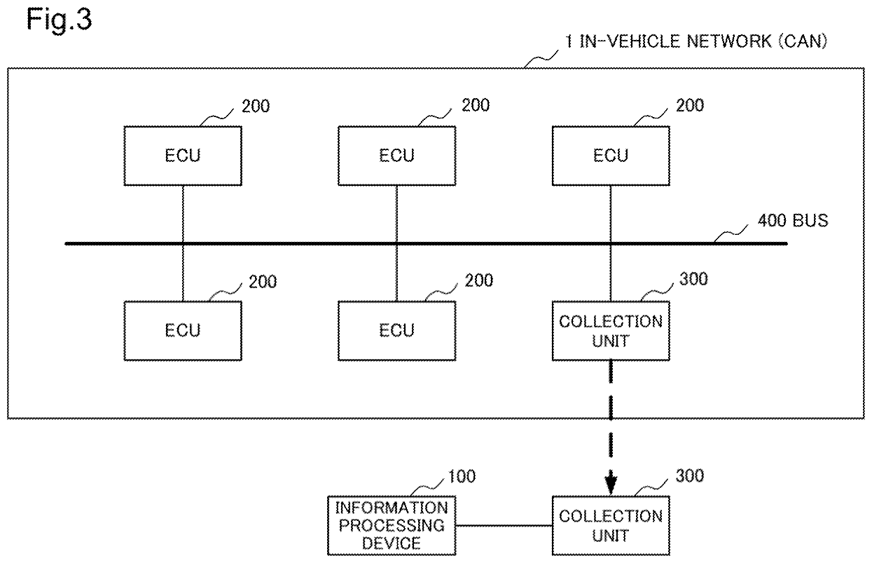

FIG. 3 is a block diagram illustrating a third example of the operation environment of the information processing device 100 according to the present example embodiment. The ECU 200 and the bus 400 illustrated in FIG. 3 are the same as the ECU 200 and the bus 400 illustrated in FIG. 1. The collection unit 300 illustrated in FIG. 3 is attached to the bus 400 of the in-vehicle network 1 similarly to the collection unit 300 illustrated in FIG. 1. Similarly to the collection unit 300 illustrated in FIG. 1, the collection unit 300 illustrated in FIG. 3 collects the data frames transmitted by the ECU 200 and flowing through the bus 400.

In the example illustrated in FIG. 3, the collection unit 300 stores the information of the collected data frame. The collection unit 300 may be, for example, a computer including a storage unit such as a non-volatile memory. Then, the collection unit 300 may store the information of the collected data frame in the storage unit. The collection unit 300 may be detachable from the in-vehicle network 1 (specifically, the bus 400). For example, the administrator of the information processing device 100 may detach the collection unit 300 from the in-vehicle network 1 and connect the detached collection unit 300 to the information processing device 100.

The information processing device 100 may read the information of the data frame from the collection unit 300 connected to the information processing device 100.

The operation environment of the information processing device 100 according to the present example embodiment is not limited to the above example. For example, the information processing device 100 may be connected to the in-vehicle network 1. In this case, the information processing device 100 (specifically, an acquisition unit 110 described later of the information processing device 100) may operate as the collection unit 300.

«Information Processing Device 100»

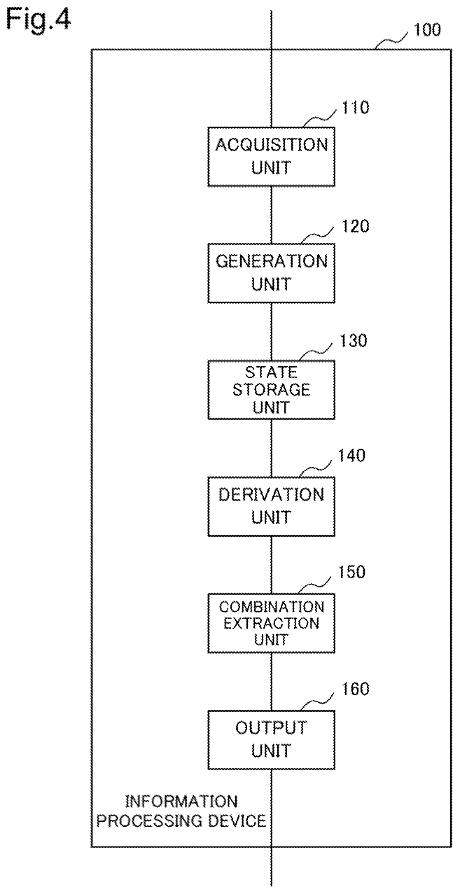

FIG. 4 is a block diagram illustrating an example of a configuration of the information processing device 100 according to the present example embodiment. In the example illustrated in FIG. 4, the information processing device 100 includes the acquisition unit 110, a generation unit 120, a state storage unit 130, a derivation unit 140, a combination extraction unit 150, and an output unit 160.

The information processing device 100 includes the acquisition unit 110 which collects a data frame which flows through the bus 400 and includes at least one parameter value, for example, via the collection unit 300 and acquires a plurality of parameters indicating a state of the device (vehicle). The information processing device 100 includes the combination extraction unit 150 which extracts a combination including two or more parameters from the plurality of parameters based on the dependency relationship between two parameters among the plurality of acquired parameters. For example, the combination extraction unit 150 extracts a combination in which the magnitude of the dependency relationship between two parameters included in the extracted combination satisfies a predetermined standard. Next, each unit of the information processing device 100 will be described in detail.

«Acquisition Unit 110»

The acquisition unit 110 acquires a plurality of parameters indicating the state of the device. As described above, in the present example embodiment, the device is, for example, a vehicle on which the in-vehicle network 1 of any one of FIGS. 1 to 3 is mounted. The acquisition unit 110 specifically acquires a plurality of parameter values indicating the state of the vehicle as the plurality of parameters indicating the state of the device. More specifically, for example, the acquisition unit 110 may acquire the plurality of parameters by receiving a plurality of data frames each including at least one parameter value from the collection unit 300 illustrated in FIG. 1. The acquisition unit 110 may acquire the plurality of parameters by reading a plurality of data frames each including at least one parameter value from the storage device 500 illustrated in FIG. 2 or the collection unit 300 illustrated in FIG. 3, for example.

The acquisition unit 110 transmits, to the generation unit 120, the information of the data frame including at least one acquired parameter value and the information (order information) that can specify the order in which the data frames are collected.

«Generation Unit 120»

The generation unit 120 receives the information of the data frame from the acquisition unit 110. The generation unit 120 generates a device state (also referred to as device state information) based on the received information of the data frame. Specifically, the generation unit 120 generates the device state based on the parameter value included in the received information of the data frame and the information that can specify the order in which the data frames are collected. The generation unit 120 outputs the generated device state. The generation unit 120 may store the generated device state in, for example, the state storage unit 130. The generation unit 120 may output the device state to another unit or another device. In the description of the present example embodiment, the generation unit 120 stores the device state in the state storage unit 130.

The above-described device state refers to information indicating the state of the device. More specifically, the device state refers to information indicating a state regarded as the state of the device at a certain timing. The device state is indicated by, for example, a combination of the plurality of parameter values described above. The device state includes a parameter value acquired as the parameter value included in the data frame. The device state may not include a parameter value set as an initial value.

As described above, in the present example embodiment, the device is a vehicle. In general, each ECU 200 described above is not necessarily designed in such a way that each ECU 200 synchronously acquires a parameter value. In particular, when the in-vehicle network 1 is a general in-vehicle network, each data frame occupies the bus 400. Therefore, a plurality of data frames is not simultaneously transmitted to the in-vehicle network 1. In other words, each data frame is transmitted at timing when no other data frame is transmitted to the bus 400. In such a case, the plurality of data frames including a plurality of parameter values acquired at different timings are transmitted to the in-vehicle network 1 at different timings. The generation unit 120 generates a device state from the plurality of parameter values included in the plurality of data frames. A method for generating the device state will be described in detail later.

The generation unit 120 may generate information indicating the transition of the device state. Then, the generation unit 120 may output the generated information indicating the transition of the device state. The information indicating the transition of the device state may be a plurality of device states including the information that can specify the order in which the device states are obtained. In the following description, the information indicating the transition of the device state is also simply referred to as the transition of the device state.

The generation unit 120 may hold a plurality of parameter values indicating a device state. In the following description, holding a device state means holding a plurality of parameter values (that is, vehicle state information) indicating the device state. In the following description, the device state held by the generation unit 120 is referred to as a “held device state”. For example, when the information processing device 100 starts operation, the generation unit 120 may set the held device state to an initial state. In the initial state, for example, the generation unit 120 may set a predetermined value indicating the initial state to each of a plurality of parameters. Then, as described in detail below, for example, when receiving the data frame from the collection unit 300 via the acquisition unit 110, the generation unit 120 may update the information indicating the device state or the transition of the device state based on the information of the received data frame. For example, the generation unit 120 may output the held device state every time a predetermined condition is satisfied. Hereinafter, the update of the device state based on the information of the received data frame and the output of the device state will be described in detail.

For example, the generation unit 120 may update the held device state by the parameter value included in the data frame in the order in which the data frames are collected by the collection unit 300. Specifically, the generation unit 120 may update the parameter value included in the received data frame in such a manner that the parameter value included in the data frame received from the collection unit 300 via the acquisition unit 110 is used to change the parameter value associated to the held device state. Accordingly, the generation unit 120 causes a change in the held device state. In the present example embodiment, an actual device state is reflected in the change of the device state held and updated by the generation unit 120. In the following description, updating the device state by the parameter value included in the data frame is also referred to as reflecting the parameter value of the data frame as the actual state of the device and reflecting the data frame in the device state.

In a case where the information that can specify the order in which the data frames are collected indicates the time when the data frames are collected, the generation unit 120 may consider that the parameter values included in the data frames indicate the actual state of the device at the time when the data frames are collected. In other words, for example, at the time when a data frame is collected, the generation unit 120 may consider that the state of the component indicated by the parameter of which the value is included in the data frame is the state indicated by the value.

In a case where the information that can specify the order in which the data frames are collected indicates an elapsed time until the time when a data frame is collected, the generation unit 120 may consider that the parameter value included in the data frame indicates the actual state of the device at the time indicated by the elapsed time. In other words, similarly, for example, at the time when a data frame is collected, the generation unit 120 may consider that the state of the component indicated by the parameter of which the value is included in the data frame is the state indicated by the value. In this case, the starting point of the elapsed time may be appropriately determined.

In a case where the information that can specify the order in which the data frames are collected is the information indicating the order, the generation unit 120 may consider that the actual state of the device becomes the state indicated by the parameter value included in the data frame in the order in which the data frames are collected. In other words, the generation unit 120 may consider that the state of the component indicated by the parameter of which the value is included in the data frame becomes the state indicated by the parameter value included in the data frame in the order in which the data frames are collected.

The generation unit 120 may output the held device state at predetermined timing, for example. In the present example embodiment, the device state output by the generation unit 120 is treated as the device state generated by the generation unit 120. The generation unit 120 may store the held device state, for example, in the state storage unit 130 at predetermined timing. For example, the generation unit 120 may output the held device state, for example, when a predetermined condition is satisfied. The generation unit 120 may store the held device state, for example, in the state storage unit 130 when a predetermined condition is satisfied.

The generation unit 120 may store the device state for each predetermined period in the state storage unit 130. In this case, the generation unit 120 may reflect, in the device state, the data frames collected in a predetermined period subsequent to the predetermined period including the time at which the data frame reflected in the device state stored immediately before is collected. Then, the generation unit 120 may store the device state reflecting these data frames in the state storage unit 130.

The generation unit 120 may store the device state in the state storage unit 130 every time a predetermined number of data frames are reflected in the device state. In other words, the generation unit 120 may newly reflect a predetermined number of unreflected data frames in the device state according to the order in which the data frames are collected. Then, the device state reflecting the predetermined number of data frames may be stored in the state storage unit 130. In other words, the generation unit 120 may repeat the reflection of the unreflected data frame in the device state and the storage of the device state in the state storage unit 130 according to the order in which the data frames are collected.

When at least one parameter value changes twice, the generation unit 120 may store the device state immediately before the second change of the at least one parameter in the state storage unit 130. The generation unit 120 may determine whether the parameter value in the device state changes by updating with the parameter value included in the data frame. Then, in a case where at least one parameter value changes twice after the device state is stored, the generation unit 120 may store the device state immediately before the second change in at least one parameter value in the state storage unit 130.

The generation unit 120 may associate the information that can specify the order of the device states with the device states stored in the state storage unit 130. The information that can specify the order of the device states may be a serial number indicating the order of the device states. The information that can specify the order of the device states may be the latest time among the times at which the data frames reflected in the device states are collected. The information that can specify the order of the device states may be the end time of the above-described predetermined period including the time when the data frame reflected in the device state is collected. The information that can specify the order of the device states may be the start time of the above-described predetermined period including the time when the data frame reflected in the device state is collected.

«State Storage Unit 130»

The state storage unit 130 stores a device state. The device state may be stored in the state storage unit 130 by the generation unit 120. The device state stored in the state storage unit 130 may be associated with information that can specify the order of the device states.

«Derivation Unit 140»

The derivation unit 140 acquires a device state. The derivation unit 140 may acquire the device state from the state storage unit 130. That is, the derivation unit 140 may read the device state from the state storage unit 130. The derivation unit 140 may receive the device state from the generation unit 120. In this case, the derivation unit 140 stores the received device state. In other words, in that case, the derivation unit 140 also operates as the state storage unit 130. In this case, the derivation unit 140 may include the state storage unit 130. Then, the derivation unit 140 may receive the device state from the generation unit 120, and store the received device state in the state storage unit 130. In the present example embodiment, the derivation unit 140 reads the device state from the state storage unit 130.

The derivation unit 140 derives a dependency relationship between two parameters among the parameters indicating the device state based on the acquired device state. Specifically, the derivation unit 140 may acquire the transition of the device state and derive the dependency relationship between two parameters among the parameters indicating the device state based on the transition of the device state. In the following description, these two parameters are also referred to as a combination of two parameters. These two parameters are also referred to as a parameter pair. Hereinafter, the dependency relationship between two parameters is also referred to as a dependency relationship of two parameters. The dependency relationship between two parameters is also referred to as a dependency relationship of a parameter pair. The dependency relationship of the combination of two parameters refers to a dependency relationship between two parameters included in the combination. The dependency relationship of the parameter pair refers to a dependency relationship between two parameters included in the parameter pair.

The derivation unit 140 may derive an index (hereinafter, also referred to as a dependence degree) indicating the magnitude of interdependence of two parameters as the dependency relationship. More specifically, the derivation unit 140 may derive the mutual information amount of two parameters as an index indicating the magnitude of the interdependence of the two parameters, that is, a dependence degree. The derivation unit 140 may derive the mutual information amount of two parameters based on the values of the two parameters included in the device state stored in the state storage unit 130. In this case, the derivation unit 140 may consider that two parameter values included in the same state of the device have occurred simultaneously.

The derivation unit 140 may derive the mutual information amount of two parameters based on a change amount of one value of the two parameters, that is, a change amount in two consecutive states of the device, and a change amount of another value of the two parameters, that is, a change amount in the same two consecutive states of the device. In other words, the derivation unit 140 may derive the mutual information amount of two parameters based on a change amount of one value of the two parameters, that is, a change amount in two consecutive device states (device state information), and a change amount of another value of the two parameters, that is, a change amount in the same two device states (device state information). In this case, the derivation unit 140 may consider that changes in two parameter values in the same two consecutive states (that is, two successive device states) of the device occur simultaneously.

The index indicating the magnitude of the interdependence of two parameters, that is, the dependence degree may be another type of value indicating the magnitude of the interdependence of the two parameters. The derivation unit 140 may normalize the value of the dependence degree in such a way that a value range changes from zero to a predetermined value (for example, one).

The derivation unit 140 may derive the above-described dependency relationship for each of combinations of two parameters among a plurality of parameters included in the device state. The derivation unit 140 may derive the above-described dependency relationship from the device states collected from a plurality of vehicles of the same type which are normally operating and confirmed not to have an unauthorized ECU attached.

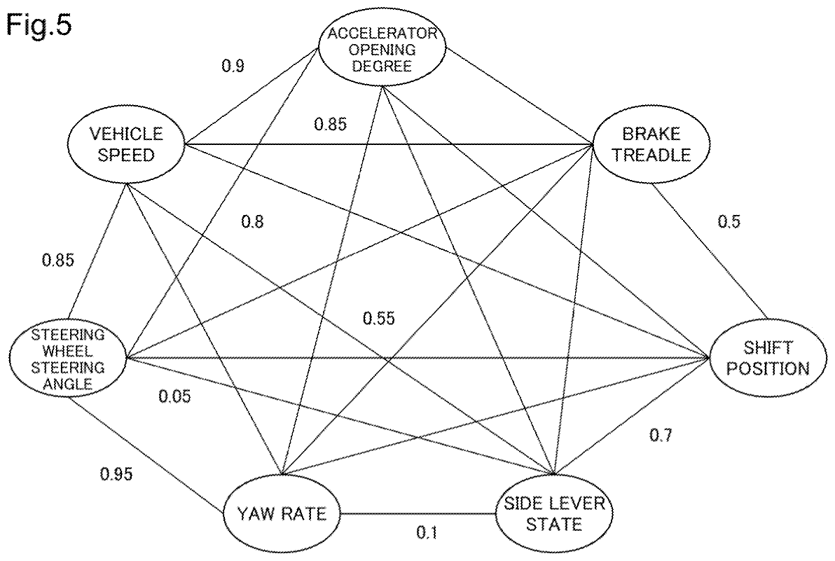

FIG. 5 is a diagram illustrating an example of a dependency relationship between parameters. In the example illustrated in FIG. 5, an ellipse indicates a parameter. A numerical value assigned to a line segment connecting two ellipses indicates the magnitude of the interdependence of two parameters indicated by the two ellipses connected by the line segment. For example, a numerical value 0.95 is assigned to a line segment connecting two ellipses indicating a steering wheel steering angle and a yaw rate. This indicates that the numerical value 0.95 is the magnitude of the interdependence between the steering wheel steering angle and the yaw rate. A numerical value 0.1 is assigned to a line segment connecting two ellipses indicating the yaw rate and a side lever state. This indicates that the numerical value 0.1 is the magnitude of the interdependence between the yaw rate and the side lever state. In the example illustrated in FIG. 5, only a part of the numerical values assigned to the line segments are illustrated for simplicity.

The derivation unit 140 transmits the derived dependency relationship to the combination extraction unit 150.

«Combination Extraction Unit 150»

The combination extraction unit 150 receives the derived dependency relationship from the derivation unit 140. As described above, the dependency relationship includes a dependency relationship of two parameters among a plurality of parameters. As described above, the dependency relationship transmitted by the derivation unit 140 and received by the combination extraction unit 150 may be a dependency relationship between two parameters in each set of two parameters among the plurality of parameters. As described above, the dependency relationship may be an index indicating the magnitude of the interdependence between two parameters. As described above, the index indicating the magnitude of the interdependence may be a mutual information amount.

The combination extraction unit 150 extracts a combination including two or more parameters based on the dependency relationship between two parameters among a plurality of parameters. Specifically, the combination extraction unit 150 extracts a combination of parameters in such a way that the magnitude of the dependency relationship between two parameters included in each of parameter pairs included in the combination of parameters satisfies a predetermined standard. In other words, the combination extraction unit 150 extracts a combination of parameters in such a way that any two parameters included in the combination of parameters have a dependency relationship of a magnitude satisfying the predetermined standard. As described above, the combination of parameters may include two or more parameters.

In the following description, a “closed combination” indicates a combination satisfying a following condition among combinations of parameters. The condition is that the magnitude of each dependency relationship between two parameters among the parameters included in the “closed combination” satisfies the predetermined standard. The “closed combination” may be referred to as “the closed combination of parameters”. The combination extraction unit 150 may extract a closed combination which is not included in another closed combination. In other words, the combination extraction unit 150 may extract a closed combination in such a way that there is no other closed combination including all parameters included in the extracted closed combination and other parameters not included in the extracted closed combination. The above-described “other closed combination” refers to a closed combination which is not identical to the above-described “extracted closed combination”.

The combination extraction unit 150 may extract all closed combinations from a plurality of parameters (that is, a plurality of parameters indicating the device state) included in the device state. The combination extraction unit 150 may extract all closed combinations which are not included in other closed combinations. In the following description, the combination extraction unit 150 extracts all closed combinations which are not included in other closed combinations.

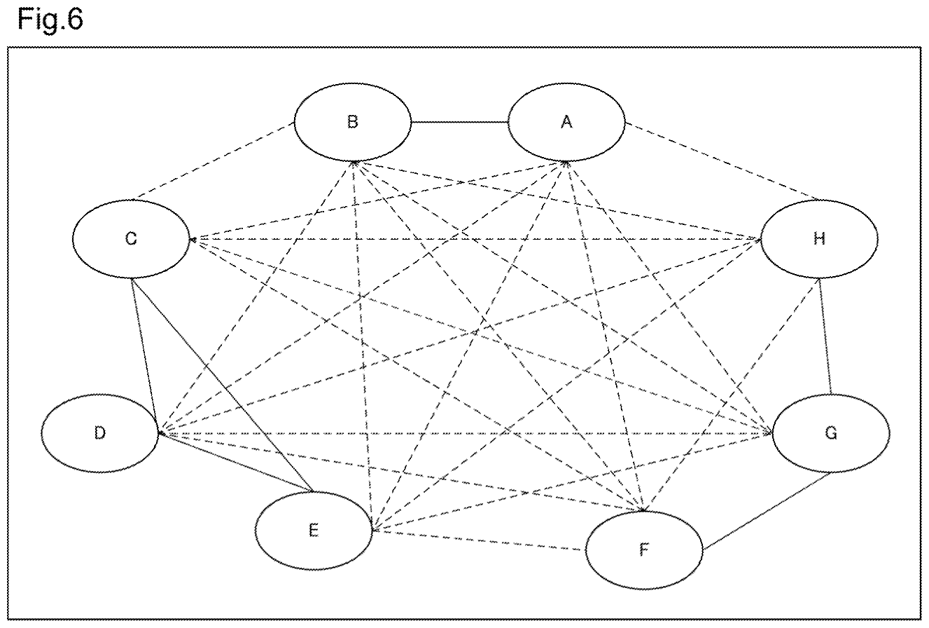

FIG. 6 is a first diagram schematically illustrating an example of the dependency relationship between parameters. In FIG. 6, ellipses assigned with letters A to H indicate parameters. Two ellipses connected by a solid line segment indicate two parameters in which the magnitude of the dependency relationship satisfies the predetermined standard. Two ellipses connected by a dashed line segment indicate two parameters in which the magnitude of the dependency relationship does not satisfy the predetermined standard.

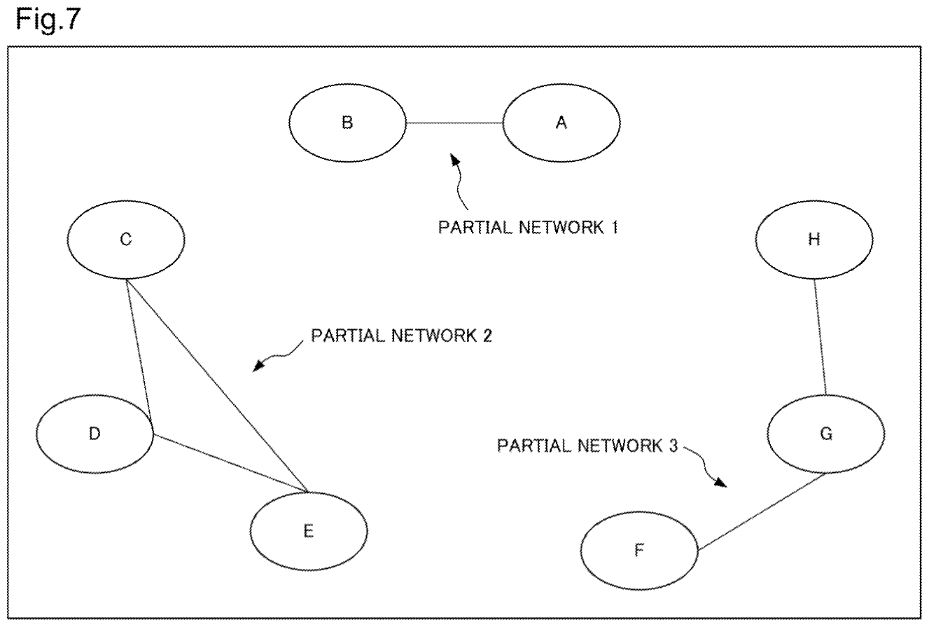

FIG. 7 is a second diagram schematically illustrating an example of the dependency relationship between parameters. In FIG. 7, among the line segments illustrated in FIG. 6, only a solid line segment is drawn. In other words, in the example illustrated in FIG. 7, a line segment is drawn only between two ellipses indicating two parameters in which the magnitude of the dependency relationship satisfies the predetermined standard. No line segment is drawn between two ellipses indicating two parameters in which the magnitude of the dependency relationship satisfies the predetermined standard.

In the example illustrated in FIG. 7, the magnitude of the interdependence between a parameter A and a parameter B satisfies the predetermined standard. The magnitude of the interdependence between the parameter A and a parameter other than the parameter B does not satisfy the predetermined standard. The magnitude of interdependence between the parameter B and a parameter other than the parameter A does not satisfy the predetermined standard. The combination extraction unit 150 extracts the combination of the parameter A and the parameter B as a closed combination.

The magnitude of the interdependence between a parameter C and a parameter D satisfies the predetermined standard. The magnitude of the interdependence between the parameter C and a parameter E satisfies the predetermined standard. The magnitude of the interdependence between the parameter D and the parameter E satisfies the predetermined standard. The magnitude of the interdependence between the parameter C and a parameter other than the parameters D and E does not satisfy the predetermined standard. The magnitude of interdependence between the parameter D and a parameter other than the parameters C and E does not satisfy the predetermined standard. The magnitude of interdependence between the parameter E and a parameter other than the parameters C and D does not satisfy the predetermined standard. The combination extraction unit 150 extracts the combination of the parameter C, the parameter D, and the parameter E as a closed combination.

The magnitude of the interdependence between a parameter F and a parameter G satisfies the predetermined standard. The magnitude of the interdependence between the parameter G and the parameter H satisfies the predetermined standard. The magnitude of interdependence between the parameter G and a parameter other than the parameters F and H does not satisfy the predetermined standard. Then, the magnitude of the interdependence between the parameter F and a parameter other than the parameter G does not satisfy the predetermined standard. The magnitude of the interdependence between the parameter H and a parameter other than the parameter G does not satisfy the predetermined standard. That is, the magnitude of the interdependence between the parameter F and the parameter H does not satisfy the predetermined standard. Therefore, the combination of the parameter F, the parameter G, and the parameter H is not a closed combination. The combination extraction unit 150 extracts the combination of the parameter F and the parameter G as a closed combination. The combination extraction unit 150 further extracts the combination of the parameter G and the parameter H as a closed combination.

FIG. 7 illustrates partial networks 1, 2, and 3. Each of the partial networks 1, 2, and 3 is a network including a node indicated by an ellipse indicating a parameter and an edge indicated by a line segment connecting ellipses. In each of these partial networks, a node is connected to each node of the partial network including the node via an edge or via an edge and another node. The partial network 1 includes nodes indicating the parameters A and B. The partial network 2 includes nodes indicating the parameters C, D, and E. The partial network 3 includes nodes indicating the parameters F, G, and H. The partial network may indicate one closed combination. The partial network may indicate a plurality of closed combinations. These partial networks will be described later.

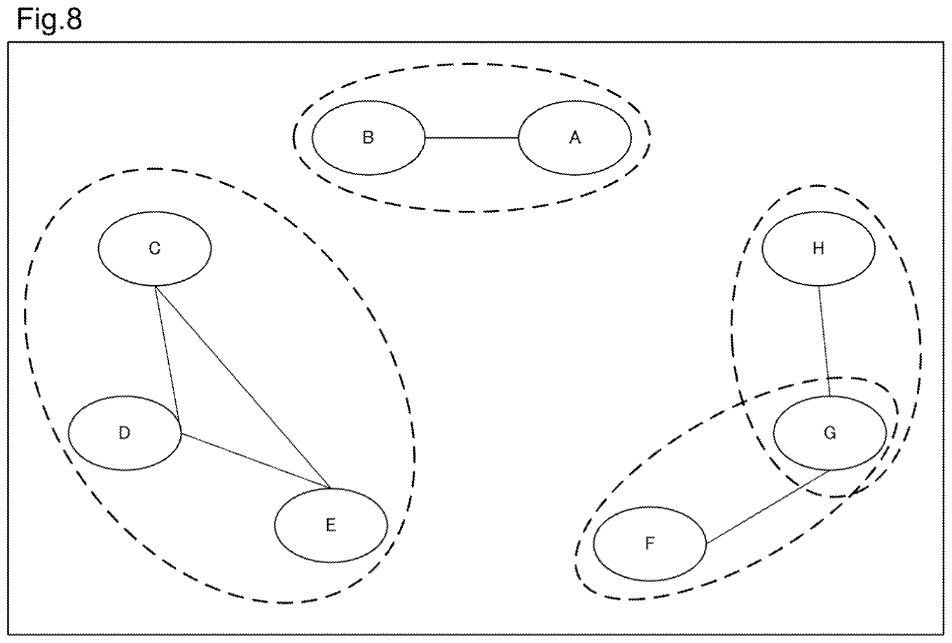

FIG. 8 is a diagram schematically illustrating an example of the extracted closed combination. In the example illustrated in FIG. 8, a combination of parameters indicated by a plurality of ellipses surrounded by a dashed ellipse is extracted as a closed combination as described above.

«Output Unit 160»

The output unit 160 outputs the information of an extracted parameter combination (that is, the extracted closed combination). The output unit 160 may display the closed combination information on a display device connected to the information processing device 100, for example. The form of the display of the closed combination information by the output unit 160 is not limited to a specific form. The display form may be a form in which the parameters included in the closed combination can be determined. The output unit 160 may output the closed combination information to another device. The format of the closed combination information output by the output unit 160 is not limited to a specific format. The format of the closed combination information may be a format in which the parameters included in the closed combination can be determined. The output unit 160 may store the closed combination information in a storage device accessible by the information processing device 100. The format of the closed combination information stored by the output unit 160 is not limited to a specific format. The format of the closed combination information may be a format in which the parameters included in the closed combination can be determined.

«Others»

The above description is given about a case where the data frame is included in one set extracted from one vehicle. However, the data frame used to extract a combination of parameters is not limited to the data frame included in one set extracted from one vehicle. The information processing device 100 may extract a combination of parameters based on a plurality of sets of data frames collected from one vehicle or a plurality of vehicles of the same type. In this case, the acquisition unit 110 may acquire a plurality of sets of data frames collected from one vehicle or a plurality of vehicles of the same type. In this case, the generation unit 120 generates a device state for each set. The derivation unit 140 derives a dependency relationship of a parameter pair based on the device state determined for each set by the plurality of sets of data frames. Then, the combination extraction unit 150 extracts a combination including two or more parameters based on the dependency relationship of each of the parameter pairs included in the plurality of parameters. In a case where data frames are collected from a plurality of types of vehicles, the information processing device 100 may extract a combination of parameters for each type of vehicle.

The information processing device according to each example embodiment of the present disclosure may be described as any of an analysis device, an extraction device, a data frame analysis device, a parameter analysis device, a dependent parameter extraction device, and the like, for example.

«Operation»

Next, the operation of the information processing device 100 according to the present example embodiment will be described in detail with reference to the drawings.

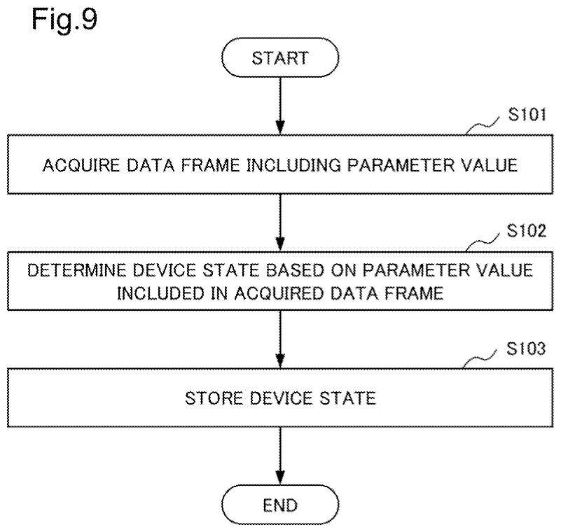

FIG. 9 is a flowchart illustrating an example of an operation of acquiring a data frame by the information processing device 100 according to the present example embodiment. In the example illustrated in FIG. 9, first, the acquisition unit 110 acquires a data frame including a parameter value (step S101). The generation unit 120 generates a device state based on the parameter value included in the acquired data frame (step S102). The generation unit 120 stores the generated device state in, for example, the state storage unit 130 (step S103).

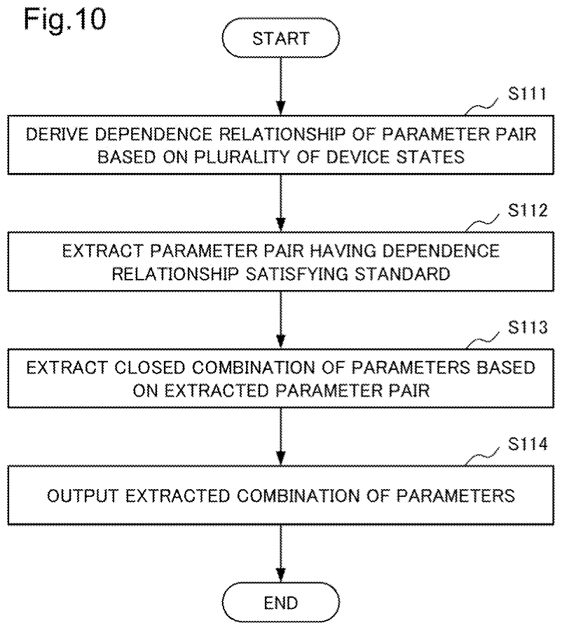

FIG. 10 is a flowchart illustrating an example of an operation of extracting a combination of parameters by the information processing device 100 of the present example embodiment. In the example illustrated in FIG. 10, the derivation unit 140 derives a dependency relationship between two parameters included in a parameter pair based on a plurality of device states stored in the state storage unit 130, for example (step S111). As described above, the derivation unit 140 may derive an index (that is, for example, the dependence degree of the mutual information amount or the like) indicating the magnitude of interdependence between two parameters as the dependency relationship between the two parameters. The derivation unit 140 may derive a dependency relationship between two parameters included in a pair for each of all possible parameter pairs included in a plurality of parameters indicating the device state.

In the example illustrated in FIG. 6, the existing parameters are eight parameters of the parameters A to H. The derivation unit 140 may derive, for each set of two parameters among these eight parameters, an index indicating the magnitude of interdependence between the two parameters.

The combination extraction unit 150 extracts a pair of parameters of which the dependency relationship satisfies a predetermined standard (step S112). For example, the combination extraction unit 150 may extract a parameter pair in which the magnitude of interdependence between two parameters included in the pair is larger than the predetermined standard from all possible parameter pairs. As described above, the magnitude of the interdependence is indicated by an index which is a dependence degree such as a mutual information amount.

The combination extraction unit 150 extracts a closed combination of parameters from a plurality of parameters based on the pair of parameters extracted in step S112 (step S113). As described above, a “closed combination of parameters” (also referred to simply as a “closed combination”) is a combination of parameters including two or more parameters. Then, in the closed combination, the dependency relationship between any two parameters satisfies the predetermined standard. The combination extraction unit 150 may extract a combination of parameters in such a way that all possible sets of two parameters have interdependence larger than the predetermined standard in the combination of parameters to be extracted. The combination extraction unit 150 may extract all such closed combinations.

As described above, in the example illustrated in FIG. 6, two ellipses connected by a solid line indicate two parameters of which the mutual relationship satisfies the predetermined standard. Two ellipses connected by a dashed line indicate two parameters of which the mutual relationship does not satisfy the predetermined standard. In FIG. 7, ellipses indicating the same parameters as those illustrated in FIG. 6 are drawn. In FIG. 7, a dashed line segment is not drawn, and only a solid line segment is drawn. That is, only ellipses indicating two parameters of which the mutual relationship satisfies the predetermined standard are connected by a line segment. In the example illustrated in FIG. 8, a dashed ellipse surrounds a combination including two or more parameters. Any set of two parameters included in the combination surrounded by the dashed ellipse is connected by a solid line. In other words, in any set of two parameters included in the combination surrounded by the dashed ellipse, the dependency relationship between the two parameters satisfies the predetermined standard. In a case where a plurality of parameters are the parameters illustrated in FIG. 6, the combination extraction unit 150 extracts each of the combinations surrounded by the dashed ellipses illustrated in FIG. 8. In this case, specifically, the combination extraction unit 150 extracts a combination of the parameters A and B, a combination of the parameters C, D, and E, a combination of the parameters F and G, and a combination of the parameters G and H.

The output unit 160 outputs the extracted combination of parameters (that is, the extracted closed combination) (step S114).

In the example illustrated in FIG. 8, the output unit 160 specifically outputs information indicating the combination of parameters A and B, the combination of parameters C, D, and E, the combination of parameters F and G, and the combination of parameters G and H. The output unit 160 may draw the diagram illustrated in FIG. 8. The output unit 160 may output, for example, information indicating the combination in a text format. The output unit 160 may output, for example, data indicating the combination in a format based on a predetermined data structure.

### Another Example of Operation

Next, another example of the operation of the information processing device 100 of the present example embodiment will be described in detail with reference to the drawings. Hereinafter, the description will be given about an example of an operation of extracting a closed combination of parameters in a case where a plurality of parameters and the dependency relationship of the parameters are indicated by a network including nodes indicating the parameters and edges indicating the dependencies. In this case, one different node is assigned to each of the plurality of parameters. In other words, each of the plurality of parameters is associated with one different node. Each node indicates one different parameter. The edge connects two nodes. An edge connecting two nodes assigned to two parameters is assigned to the dependency relationship between the two parameters. In other words, the dependency relationship between two parameters is associated with an edge connecting two nodes assigned to the two parameters. An edge indicates a dependency relationship between two nodes. In an initial state, all two nodes are connected by an edge. FIG. 6 illustrates an example of such a network where a plurality of parameters is parameters A to H. Ellipses including letters A to H indicate the nodes indicating the parameters A to H, respectively. In the following description, the nodes indicated by the ellipses including the letters A to H are referred to as nodes A to H, respectively. A line segment connecting ellipses indicates an edge connecting nodes. In the example illustrated in FIG. 6, the line segment indicating the edge is drawn by a solid line or a dashed line.

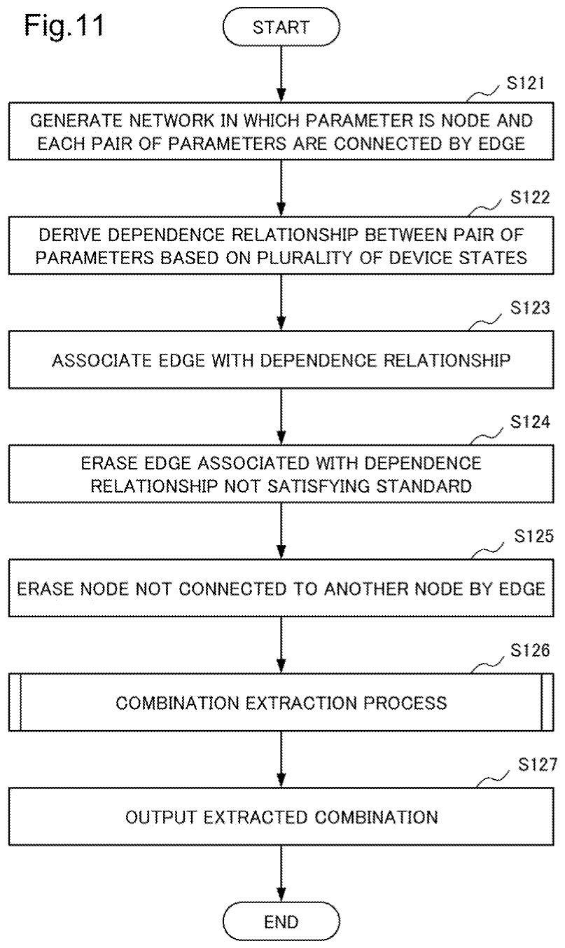

FIG. 11 is a flowchart illustrating an example of the operation of extracting a combination of parameters by the information processing device 100 of the present example embodiment. In the example illustrated in FIG. 11, the derivation unit 140 generates the above-described network in the initial state (step S121). As described above, the network includes a plurality of nodes respectively indicating a plurality of parameters. In the initial state, all the two nodes are connected by an edge. An edge indicates a dependency relationship between two parameters respectively indicated by two nodes to which the edge connects.

Then, the derivation unit 140 derives a dependency relationship between two parameters based on a plurality of device states (step S122). The operation in step S122 is the same as the operation in step S111 in FIG. 10. That is, the derivation unit 140 may derive an index indicating the magnitude of interdependence between two parameters as the dependency relationship between the two parameters.

Next, the derivation unit 140 associates an edge with the dependency relationship (step S123). Specifically, the derivation unit 140 associates the dependency relationship between two parameters (that is, two parameters included in a parameter pair) with an edge connecting two nodes associated with the two parameters. In other words, the derivation unit 140 assigns an index indicating the magnitude of interdependence between two parameters to an edge connecting two nodes respectively indicating the two parameters.

The combination extraction unit 150 erases, from the network, the edge associated with a dependency relationship not satisfying the predetermined standard (step S124). Specifically, for example, the combination extraction unit 150 erases, from the network, the edge assigned with an index smaller than a predetermined value.

In the example illustrated in FIG. 6, the edge drawn by a solid line is the edge associated with a dependency relationship satisfying the predetermined standard. The edge drawn by a dashed line is the edge associated with a dependency relationship not satisfying the predetermined standard. In a case where the network is the network illustrated in FIG. 6, the combination extraction unit 150 erases the edge drawn by the dashed line.

When the edge associated with the dependency relationship not satisfying the predetermined standard is erased, the edge associated with the dependency satisfying the predetermined standard remains. In other words, when the dependency relationship between two parameters satisfies the predetermined standard, the nodes indicated by the two parameters are connected by an edge. When the dependency relationship between two parameters does not satisfy the predetermined standard, the nodes indicated by the two parameters are not connected by an edge.

The combination extraction unit 150 may further erase a node not connected to another node by an edge (step S125). If a node is not connected to another node by an edge, the magnitude of interdependence between the node and each of the other parameters does not satisfy the predetermined standard. Therefore, a parameter indicated by a node which is not connected to another node by an edge is not included in any closed combination. Therefore, the combination extraction unit 150 may erase the node which is not connected to another node by an edge.

When the edge associated with a dependency relationship not satisfying the predetermined standard is erased from the network illustrated in FIG. 6, the edge drawn by a solid line segment in FIG. 7 remains.

In a case where the dependency relationship between at least two parameters satisfies the predetermined standard, as a result of step S125, one or more partial networks are generated. The partial network is a network including at least two nodes connected by an edge among a plurality of nodes indicating a device state. Each node included in the partial network is connected to all the other nodes included in the partial network via an edge or two or more edges and another one or more nodes. In other words, in the partial network, each node can lead to all other nodes via an edge or via a plurality of edges and one or more other nodes. In the partial network, each node does not need to be directly connected to all other nodes by an edge. In the partial network, there may be a set of two nodes which are not directly connected by an edge.

In the example illustrated in FIG. 6, as illustrated in FIG. 7, a partial network including the nodes A and B, a partial network including the nodes C, D, and E, and a partial network including the nodes F, G, and H are generated. In the following description, the partial network including the nodes A and B is referred to as a partial network 1. The partial network including the nodes C, D, and E is referred to as a partial network 2. The partial network including the nodes F, G, and H is referred to as a partial network 3.

In a case where there is no partial network, that is, in a case where all the edges connecting nodes are erased in step S124, the information processing device 100 may display information indicating that there is no combination. In that case, the information processing device 100 may end the operation illustrated in FIG. 11.

The combination extraction unit 150 executes a combination extraction process of extracting a closed combination from the partial network (step S126). The combination extraction process will be described in detail later.

FIG. 8 indicates the closed combination extracted in step S126 from the partial network illustrated in FIG. 7. In FIG. 8, nodes and edges included in the extracted closed combination are surrounded by dashed ellipses. A combination of the nodes A and B, a combination of the nodes C, D, and E, a combination of the nodes F and G, and a combination of the nodes G and H are extracted as closed combinations.

The output unit 160 outputs the extracted closed combination (that is, information indicating the extracted closed combination) (step S127).

Next, an operation of the combination extraction process of the information processing device 100 according to the present example embodiment will be described in detail with reference to the drawings.

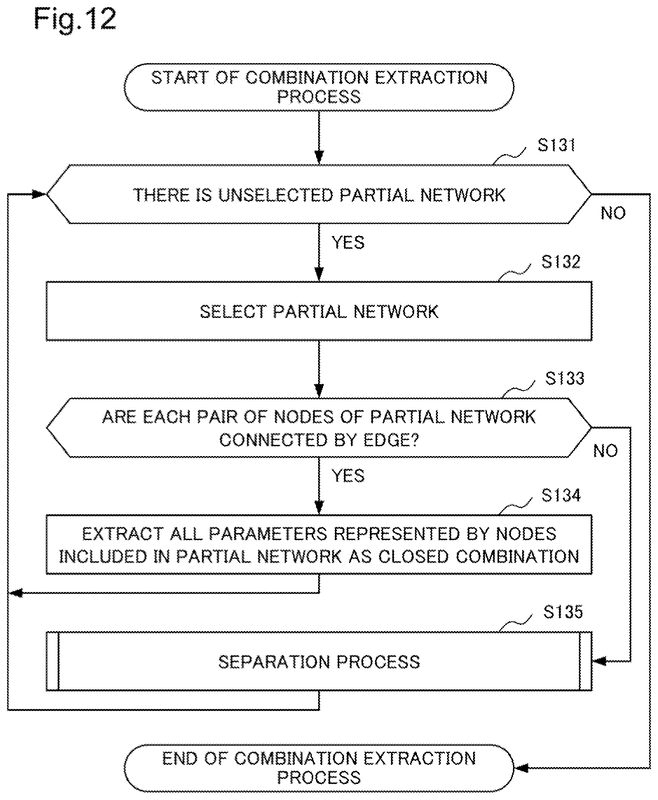

FIG. 12 is a flowchart illustrating an example of the operation of the combination extraction process of the information processing device 100 of the present example embodiment. In the example illustrated in FIG. 12, the combination extraction unit 150 determines whether there is an unselected partial network (step S131). In a first combination extraction process, no existing partial network is selected. In a case where there is no unselected partial network (NO in step S131), that is, in a case where all the existing partial networks are selected, the information processing device 100 ends the operation illustrated in FIG. 12. In a case where there is an unselected partial network (YES in step S131), the combination extraction unit 150 selects one partial network from the unselected partial networks (step S132).

The combination extraction unit 150 determines whether each pair of nodes of the selected partial network is connected by an edge (step S133). In a case where each pair of nodes of the selected partial network are connected by an edge (YES in step S133), each parameter pair included in the parameters indicated by the nodes included in the partial network has a dependency relationship satisfying the predetermined standard. In this case, the combination extraction unit 150 extracts a combination of parameters indicated by the nodes included in the selected partial network as a closed combination (step S134).

In the example illustrated in FIG. 7, the partial network 1 includes the node A and the node B. The node A and the node B are connected to each other by an edge. The partial network 2 includes the node C, the node D, and the node E. Therefore, the combination of the parameters indicated by the nodes included in the partial network 1 is a closed combination. The node C and the node D are connected to each other by an edge. The node D and the node E are connected to each other by an edge. The node E and the node C are connected to each other by an edge. Therefore, the combination of the parameters indicated by the nodes included in the partial network 2 is a closed combination. Therefore, when the partial network 1 or the partial network 2 is selected, the combination of the parameters indicated by the nodes included in the selected partial network is extracted as a closed combination.

The partial network 3 includes the node F, the node G, and the node H. The node F and the node G are connected to each other by an edge. The node G and the node H are connected to each other by an edge. However, the node F and the node H are not connected by an edge. Therefore, the partial network 3 is not a network in which all combinations of parameters indicated by the nodes included in the network are closed combinations.

When at least one node pair of the selected partial network is not connected by an edge (NO in step S133), the combination extraction unit 150 performs a separation process (step S135). The combination extraction unit 150 extracts a plurality of closed combinations, each of which is a part of the partial network, from the selected partial network by the separation process. The separation process will be described in detail later. After step S135, the operation of the information processing device 100 returns to step S131.

In the partial network 3 illustrated in FIG. 7, the node F and the node G are connected to each other by an edge. Therefore, the combination of the parameters indicated by the node F and the node G (that is, the combination of the parameter F and the parameter G) is a closed combination. The node G and the node H are connected to each other by an edge. Therefore, the combination of the parameters indicated by the node G and the node H (that is, the combination of the parameter G and the parameter H) is a closed combination. The separation process extracts the above-described two closed combinations from the partial network 3.

Next, the operation of the separation process of the information processing device 100 according to the present example embodiment will be described in detail with reference to the drawings.

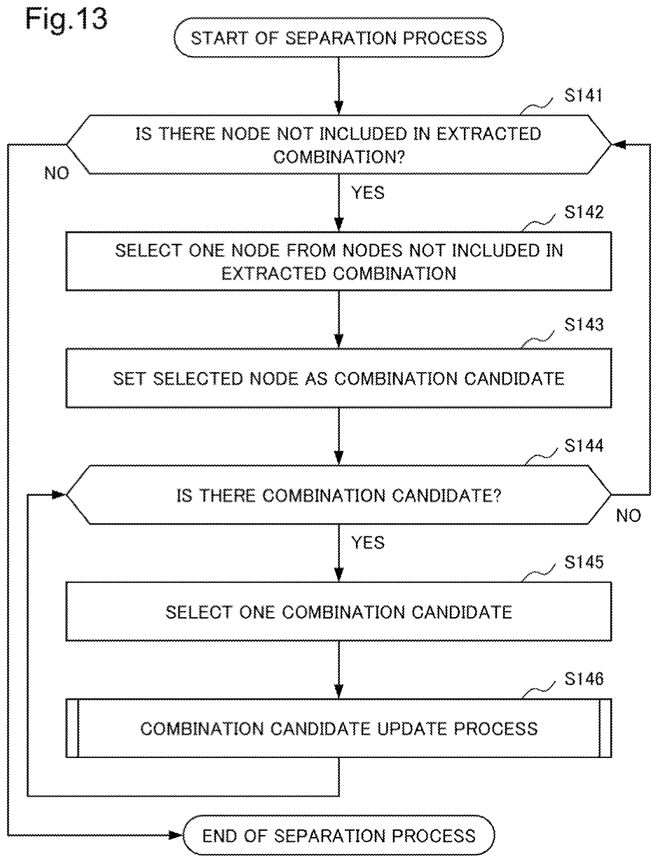

FIG. 13 is a flowchart illustrating an example of the operation of the separation process of the information processing device 100 of the present example embodiment. When the operation illustrated in FIG. 13 is started, one partial network is selected. The partial network selected when the operation illustrated in FIG. 13 is started is the partial network selected in step S132 in FIG. 12. The target of the operation illustrated in FIG. 13 is a node included in the selected partial network. Then, there is no node included in the combination extracted as a closed combination among the nodes included in the selected partial network.

In the example illustrated in FIG. 7, the partial network 1 and the partial network 2 each indicate a closed combination. Therefore, when the partial network 1 is selected and when the partial network 2 is selected, the operation in step S135 in FIG. 12 is not performed. The entire parameters indicated by the nodes included in the partial network 3 are not a closed combination. Thus, the partial network 3 of FIG. 7 may be the partial network selected at the start of the operation illustrated in FIG. 13. The partial network selected when the operation illustrated in FIG. 13 is started is a partial network which has not been selected as a partial network indicating a closed combination in step S134 of FIG. 12. Therefore, all the nodes included in the partial network selected when the operation illustrated in FIG. 13 is started are not included in the extracted closed combination.

The combination extraction unit 150 determines whether there is a node not included in the combination (hereinafter, also simply referred to as an extracted combination) extracted as the closed combination (step S141). In a case where there is no node not included in the extracted combination (NO in step S141), the information processing device 100 ends the operation of the separation process illustrated in FIG. 13. In a case where there is a node not included in the extracted combination (YES in step S141), the combination extraction unit 150 selects one node from the nodes not included in the extracted combination.

In the first operation of step S141 after the operation illustrated in FIG. 13 is started, as described above, the nodes included in the selected partial network are not included in the combination extracted as a closed combination. In this case, in step S142, the combination extraction unit 150 selects one node from the nodes included in the selected partial network.

The combination extraction unit 150 sets the selected node as a combination candidate (step S143). The combination candidate in step S143 includes only one node selected in step S142. The operation of the information processing device 100 proceeds to step S144.

In step S144, the combination extraction unit 150 determines whether there is a combination candidate. When there is a combination candidate (YES in step S144), the combination extraction unit 150 selects one combination candidate from the existing combination candidates (step S145). The information processing device 100 performs a combination candidate update process on the selected combination candidate (step S146).

In the combination candidate update process, the selected combination candidate is replaced with one or more new combination candidates or excluded from the combination candidates. Each of the one or more new combinations which replace the selected combination candidate includes the selected combination candidate. In a case where the selected combination candidate is extracted as a closed combination, the combination candidate is excluded from the combination candidates. Even in a case where it is determined that the combination including the selected combination candidate is not selected as a closed combination, the selected combination candidate is excluded from the combination candidates. In a case where the selected combination candidate is excluded from the combination candidates, the combination candidate does not exist. In a case where the combination candidate which is the node selected in step S142 and all the combination candidates obtained by replacing the combination candidate are excluded from the combination candidates, the combination candidate does not exist. The combination candidate update process will be described in detail later.

After the combination candidate update process of step S146, the operation of the information processing device 100 returns to step S144.

In a case where the combination candidate selected in step S145 is replaced with a new combination candidate in step S146, the new combination candidate exists. That is, there is a combination candidate (YES in step S144). In this case, the information processing device 100 performs the operations in and after step S145 again. In a case where there is a combination candidate which has not been selected in step S145, there is at least unselected combination candidate. That is, there is a combination candidate (YES in step S144). Also in this case, the information processing device 100 performs the operations in and after step S145 again.

In a case where there is no combination candidate (NO in step S144), the operation of the information processing device 100 returns to step S141. As described above, when there is a node not included in the combination extracted as a closed combination in the selected partial network (YES in step S141), the information processing device 100 performs the operations in and after step S142 again. In a case where a node not included in the combination extracted as a closed combination exists in the selected partial network, there is a possibility that another closed combination including the node exists in the selected partial network. There is a possibility that such a closed combination is extracted by the operation in and after step S142. In case where no node not included in the combination extracted as a closed combination exists in the selected partial network (NO in step S141), the information processing device 100 ends the operation illustrated in FIG. 13.

Next, an example of the operation of the combination candidate update process of the information processing device 100 according to the present example embodiment will be described in detail with reference to the drawings.

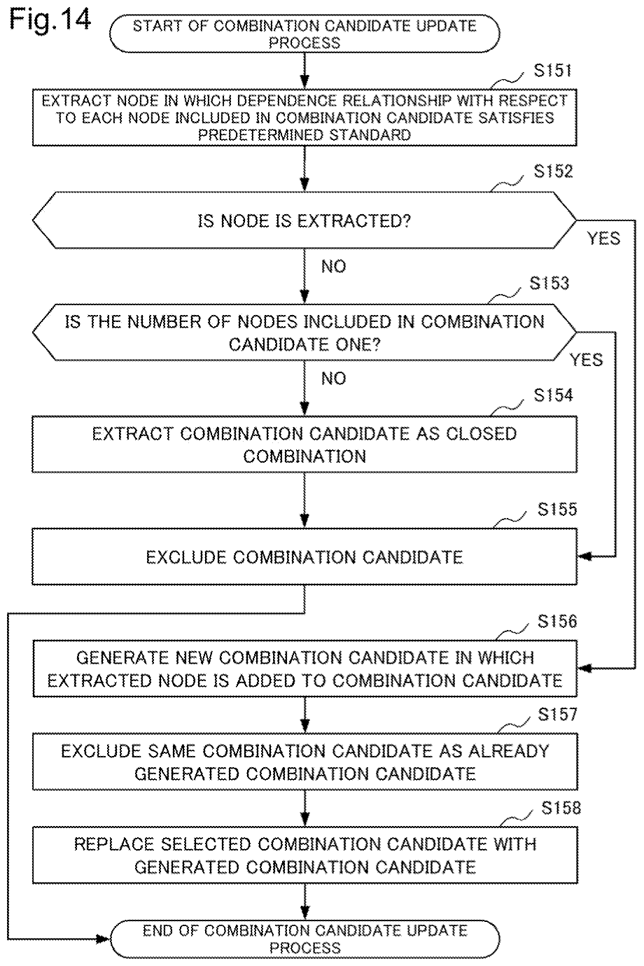

FIG. 14 is a flowchart illustrating the example of the operation of the combination candidate update process of the information processing device 100 of the present example embodiment. At the start of the operation illustrated in FIG. 14, one combination candidate is selected. The combination candidate selected at the start of the operation illustrated in FIG. 14 is one node or a closed combination. Then, there is a possibility that there is a node in which the dependency relationship with respect to each node included in the combination candidate satisfies the predetermined standard. In other words, there is a possibility that there is a closed combination including all the nodes included in the selected combination candidate and another node.

The combination extraction unit 150 extracts a node of which the dependency relationship with respect to each node included in the selected combination candidate satisfies the predetermined standard (step S151). In other words, the combination extraction unit 150 performs a process of extracting a node of which the dependency relationship with respect to each node included in the selected combination candidate satisfies the predetermined standard. In a case where a node of which the dependency relationship with respect to each node included in the selected combination candidate satisfies the predetermined standard is extracted, the operation of step S151 may be ended. In this case, the combination extraction unit 150 may extract all the nodes each having the dependency relationship with respect to each node included in the selected combination candidate satisfying the predetermined standard. The combination extraction unit 150 may end the operation of step S151 also in a case where it is confirmed that there is no node of which the dependency relationship with respect to each node included in the selected combination candidate satisfies the predetermined standard. In a case where there is no node of which the dependency relationship with respect to each node included in the selected combination candidate satisfies the predetermined standard, the node is not extracted in step S151.

In a case where no node is extracted in step S151 (NO in step S152), there is no node of which the dependency relationship with respect to each node included in the selected combination candidate satisfies the predetermined standard. In other words, there is no closed combination including all nodes of the selected combination candidate and another node. In a case where the selected combination candidate includes only one node, there is no closed combination including the node included in the combination candidate. In a case where the number of nodes included in the selected combination candidate is two or more, the selected combination candidate is a closed combination. Therefore, in this case, there is no closed combination including a node not included in the selected combination candidate in addition to all the nodes of the selected combination candidate.

In a case where no node is extracted in step S151 (NO in step S152), the combination extraction unit 150 determines whether the number of nodes included in the selected combination candidate is one (step S153). In a case where the number of nodes included in the selected combination candidate is not one (NO in step S153), the combination extraction unit 150 extracts the selected combination candidate as a closed combination (step S154). Then, the combination extraction unit 150 excludes the combination candidate extracted as a closed combination from the combination candidates (step S155). Then, the information processing device 100 ends the operation illustrated in FIG. 14.

In a case where the number of nodes included in the selected combination candidate is one (YES in step S153), no node of which the dependency relationship with the node of the selected combination candidate satisfies the predetermined standard exists in the partial network selected at the start of the operation illustrated in FIG. 12. In this case, the combination extraction unit 150 excludes the selected combination candidate from the combination candidates (step S155). Then, the information processing device 100 ends the operation illustrated in FIG. 14.

In a case where a node is extracted in step S151 (YES in step S152), that is, in a case where one or more nodes are extracted, next, the information processing device 100 performs the operation in step S156.

In step S156, the combination extraction unit 150 generates a new combination candidate in which the node extracted in step S151 is added to the selected combination candidate (step S156). In a case where only one node is extracted in step S151, the combination extraction unit 150 may generate a new combination candidate in which the extracted node is added to the selected combination candidate. In a case where a plurality of nodes are extracted in step S151, the combination extraction unit 150 may generate a plurality of new combination candidates in which different one of the extracted nodes is added to the selected combination candidate. In step S151, for example, in a case where N nodes are extracted, the combination extraction unit 150 may generate N different new combination candidates each obtained by adding one of the extracted N nodes to the selected combination candidate. The combination extraction unit 150 stores the newly generated combination candidate. Specifically, the combination extraction unit 150 stores information capable of specifying a node included in the newly generated combination candidate.

Next, the combination extraction unit 150 excludes the same combination candidate as the already generated combination candidate from the newly generated combination candidates (step S157). In other words, in step S157, the combination extraction unit 150 erases the same combination candidate as the already generated combination candidate among the new combination candidates generated in step S156. Then, the combination extraction unit 150 replaces the selected combination candidate with the generated combination candidate (specifically, the combination candidate generated in step S156 and not excluded in step S157). The combination extraction unit 150 may simply exclude the combination candidate selected at the start of the operation illustrated in FIG. 14 from the combination candidates. In other words, the combination extraction unit 150 may erase the combination candidate selected at the start of the operation illustrated in FIG. 14. In a case where all of the new combination candidates generated in step S156 are excluded in step S157, the combination extraction unit 150 may simply erase the combination candidate selected at the start of the operation illustrated in FIG. 14. Then, the information processing device 100 ends the operation illustrated in FIG. 14.

In step S156, the combination extraction unit 150 may not necessarily generate all the new combination candidates in which any one of all the extracted nodes is added to the selected combination candidate. For example, in a case where the combination in which one of the extracted nodes is added to the selected combination candidate is the same as any of the already generated combination candidates, the combination extraction unit 150 may not generate such a combination as a new combination candidate. In the case of not generating a combination candidate that is the same as any of the already generated combination candidates, the combination extraction unit 150 may not perform the operation of step S157.

Next, still another example of the operation of extracting a combination of parameters by the information processing device 100 according to the present example embodiment will be described in detail with reference to the drawings.

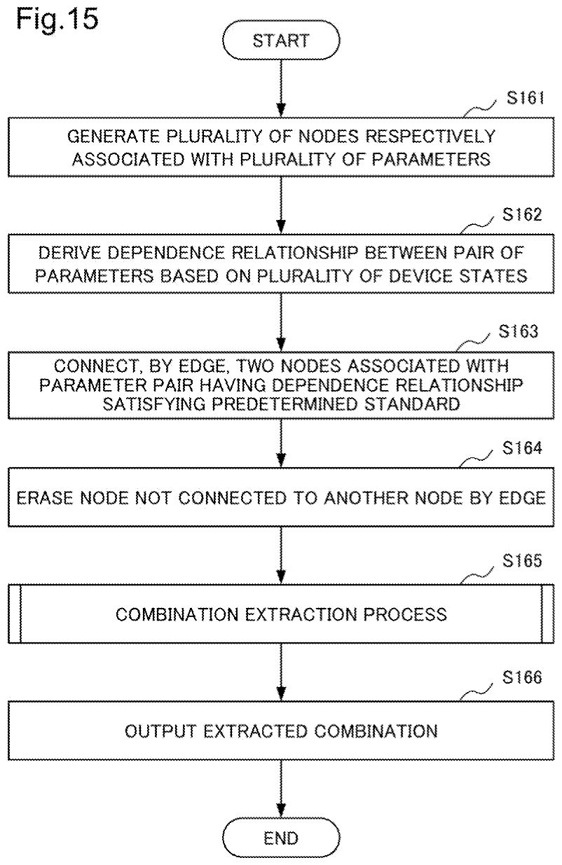

FIG. 15 is a flowchart illustrating still another example of the operation of extracting the combination of parameters by the information processing device 100 of the present example embodiment. The information processing device 100 may perform the operation illustrated in FIG. 15 instead of the operation illustrated in FIG. 11.

In the example illustrated in FIG. 15, the derivation unit 140 generates a plurality of nodes respectively associated with a plurality of parameters indicating the device state (step S161). Unlike the example illustrated in FIG. 11, in the example illustrated in FIG. 15, the derivation unit 140 does not generate an edge connecting nodes before deriving the dependency relationship of a parameter pair (that is, the dependency relationship between two parameters included in the parameter pair).

Next, the derivation unit 140 derives the dependency relationship of a parameter pair (that is, the dependency relationship between two parameters) based on a plurality of device states (step S162). The operation of step S162 is the same as the operation of step S122 illustrated in FIG. 11.

Next, the combination extraction unit 150 connects, by an edge, two nodes associated with the parameter pair of which the dependency relationship satisfies the predetermined standard (step S163). In the example illustrated in FIG. 15, the combination extraction unit 150 does not connect all nodes by edges, but connects the nodes associated with the parameter pairs having the dependency relationship satisfying a predetermined condition by edges.

In the example illustrated in FIG. 15, in steps of step S164 to step S166, the information processing device 100 performs the same operation as the operation of the steps of step S125 to step S127 illustrated in FIG. 11, respectively.

The operations illustrated in FIGS. 11 to 15 described above are examples of the operation of the information processing device 100. The information processing device 100 may extract a closed combination of parameters by performing an operation different from the operation illustrated in FIGS. 11 to 15. For example, the operation illustrated in FIGS. 11 to 15 is an example of the operation in which the information processing device 100 generates a network including a node indicating a parameter and an edge associated with a dependence degree, and extracts a closed combination using the generated network. However, the information processing device 100 may extract a closed combination without using such a network.

«Effects»

The present example embodiment has a first effect that relevant parameters can be extracted without depending on human knowledge. The present example embodiment also has a second effect that a new combination of relevant signals that cannot be obtained with human knowledge can be obtained. The present example embodiment also has a third effect that a plurality of parameters having a dependent relationship can be extracted while reducing the cost of calculation. This is because the combination extraction unit 150 extracts a combination including two or more parameters from the plurality of parameters based on the dependency relationship of a parameter pair included in the plurality of parameters. Therefore, relevant parameters can be obtained regardless of human knowledge. In other words, relevant parameters which do not depend on human knowledge are obtained. Also, relevant parameters that are usually unimaginable, in other words, not obtained with human knowledge, may be obtained. Also, in a case where there are many types of parameters, those parameters can be used to generate a vast number of combinations, each including two or more parameters. Therefore, in order to extract a combination related to all the included parameters from a combination of two or more parameters that can be generated from a large number of types of parameters, enormous calculation is required. In the present example embodiment, a dependency relationship between parameters is determined for each of combinations of two parameters that can be generated from many types of parameters. Then, a closed combination is extracted based on the combination including two parameters relevant to each other. In the present example embodiment, in a case where there are a large number of types of parameters, it is not necessary to perform a calculation of directly determining a dependency relationship among all the parameters included in the combination on a combination of three or more parameters that can be generated from those parameters. Therefore, even when there are many types of parameters, the amount of calculation can be reduced.

«Modifications»

Next, a modification of the information processing device 100 of the present example embodiment will be described in detail with reference to the drawings. The information processing device 100 of the present example embodiment may be configured as each modification described below. In each modification described below, each of the acquisition unit 110, the generation unit 120, the state storage unit 130, the derivation unit 140, the combination extraction unit 150, and the output unit 160 has the same function as the unit assigned with the same name and the same reference sign in the first example embodiment. An extraction unit 170 includes the combination extraction unit 150. The extraction unit 170 may include at least one of the generation unit 120, the state storage unit 130, the derivation unit 140, and the output unit 160. Then, the extraction unit 170 operates as a unit included in the extraction unit 170. A second information processing device 102 may be achieved by a plurality of information processing devices each including at least one unit. In the following modification, transmission and reception of data between a plurality of units included in the same device are performed via a bus or the like that connects the plurality of units. Transmission and reception of data between a plurality of units included in different devices are performed via a communication network or the like that connects the plurality of devices. The information processing device 100 of each modification operates similarly to the information processing device 100 of the first example embodiment except for the difference based on the above configuration difference. Hereinafter, a configuration of the modification of the present example embodiment will be described in detail.

(First Modification)

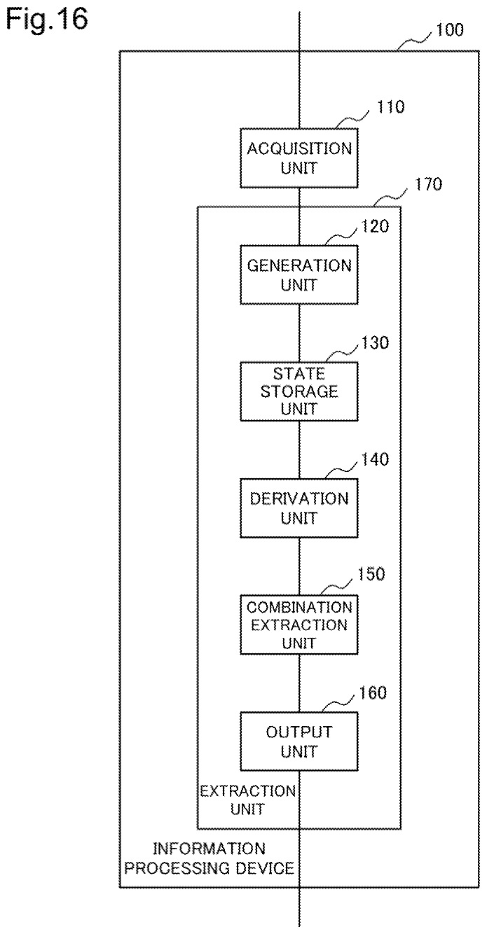

FIG. 16 is a diagram illustrating a configuration of the information processing device 100 according to a first modification. In the first modification, the information processing device 100 includes the acquisition unit 110 and the extraction unit 170. The extraction unit 170 of the present modification includes the combination extraction unit 150. The extraction unit 170 further includes the generation unit 120, the state storage unit 130, the derivation unit 140, and the output unit 160.

In the first modification, the extraction unit 170 operates as the generation unit 120, the state storage unit 130, the derivation unit 140, the combination extraction unit 150, and the output unit 160.

(Second Modification)

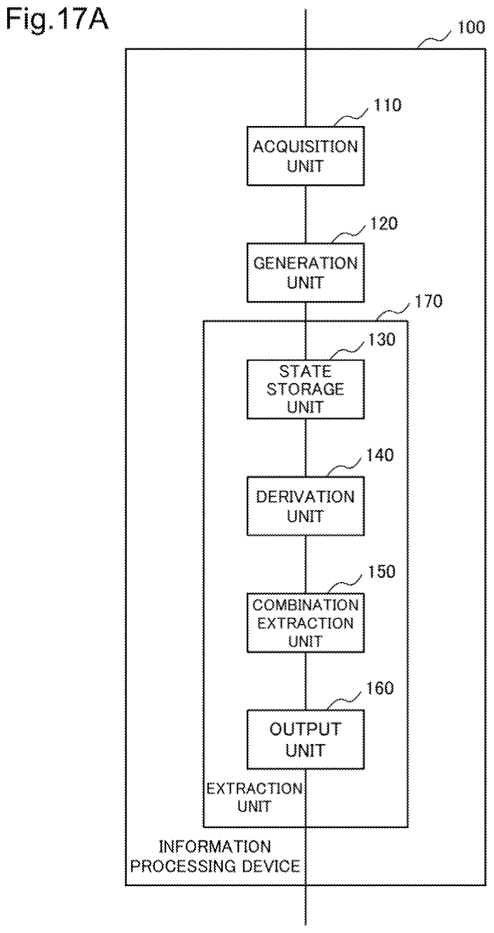

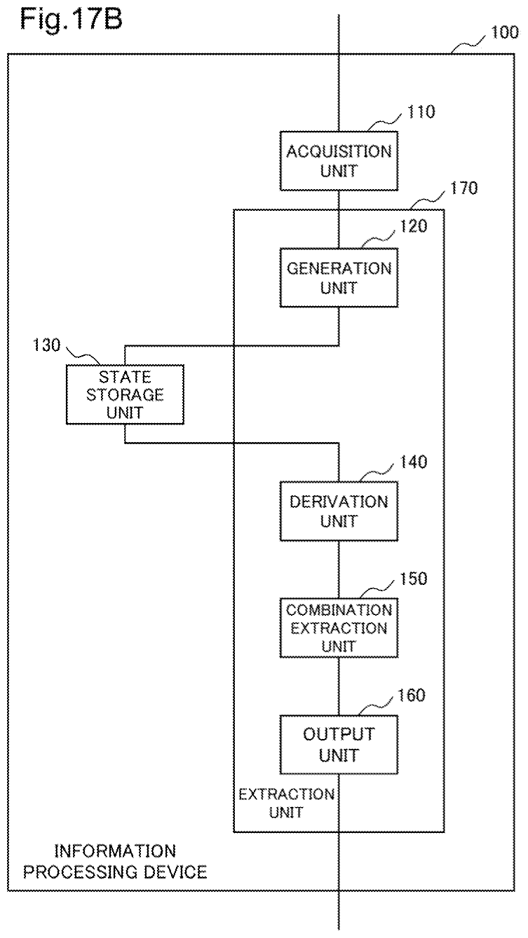

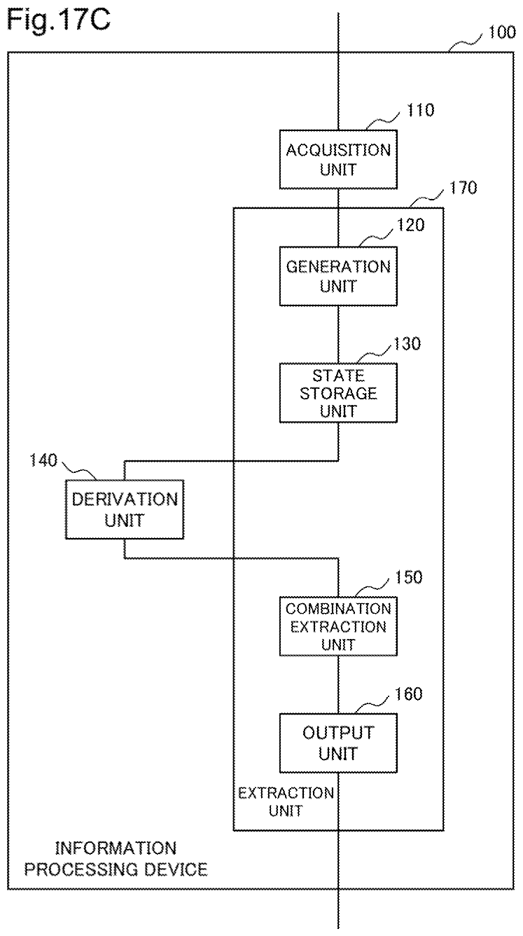

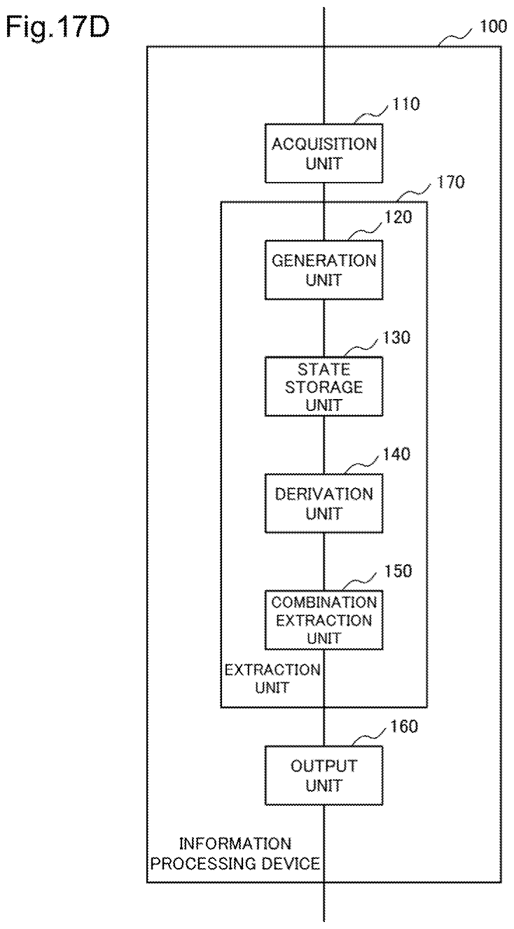

FIGS. 17A, 17B, 17C, and 17D are diagrams each illustrating a configuration of the information processing device 100 according to a second modification. In the second modification, the information processing device 100 includes the acquisition unit 110 and the extraction unit 170. The extraction unit 170 of the present modification includes the combination extraction unit 150. The extraction unit 170 further includes three of the generation unit 120, the state storage unit 130, the derivation unit 140, and the output unit 160. The information processing device 100 further includes one unit not included in the extraction unit 170 among the generation unit 120, the state storage unit 130, the derivation unit 140, and the output unit 160.

In a case where the configuration of the information processing device 100 is the configuration illustrated in FIG. 17A (also referred to as a first aspect of the second modification), the extraction unit 170 operates as the state storage unit 130, the derivation unit 140, the combination extraction unit 150, and the output unit 160. In a case where the configuration of the information processing device 100 is the configuration illustrated in FIG. 17B (also referred to as a second aspect of the second modification), the extraction unit 170 operates as the generation unit 120, the derivation unit 140, the combination extraction unit 150, and the output unit 160. In a case where the configuration of the information processing device 100 is the configuration illustrated in FIG. 17C (also referred to as a third aspect of the second modification), the extraction unit 170 operates as the generation unit 120, the state storage unit 130, the combination extraction unit 150, and the output unit 160. In a case where the configuration of the information processing device 100 is the configuration illustrated in FIG. 17D (also referred to as a fourth aspect of the second modification), the extraction unit 170 operates as the generation unit 120, the state storage unit 130, the derivation unit 140, and the combination extraction unit 150.

(Third Modification)

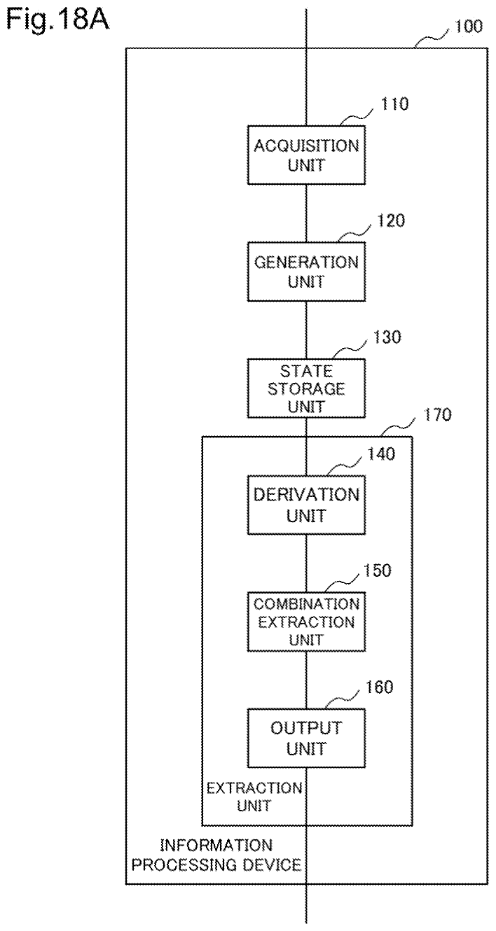

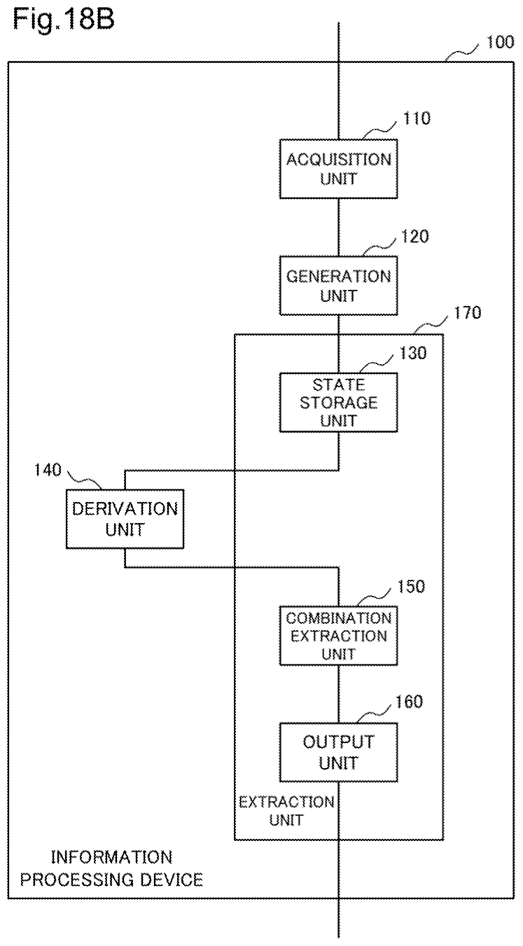

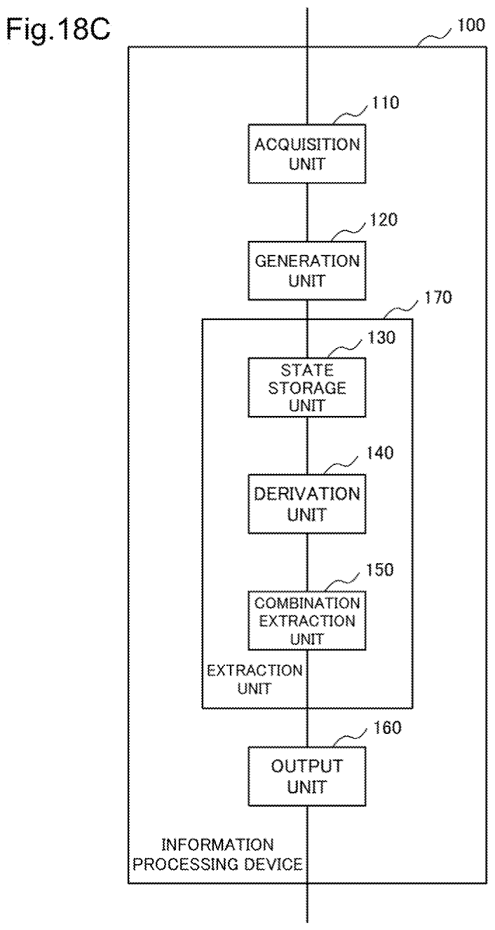

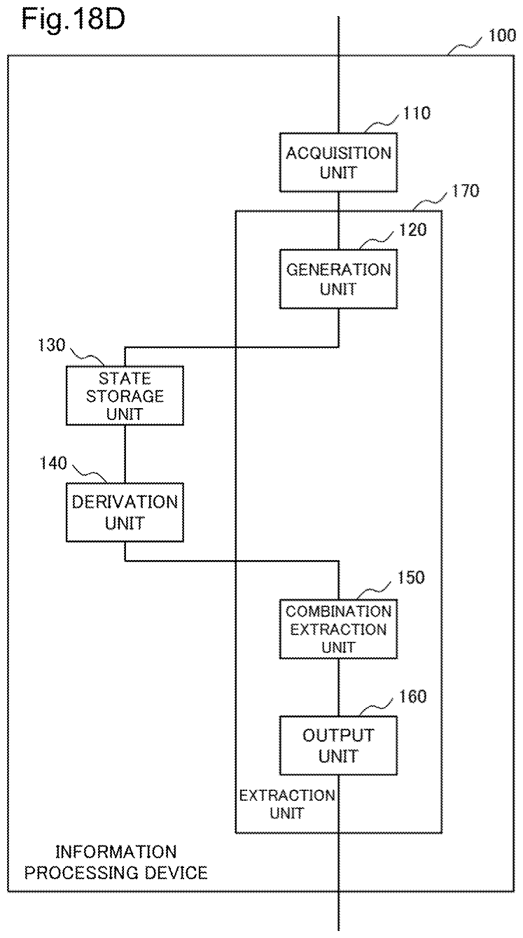

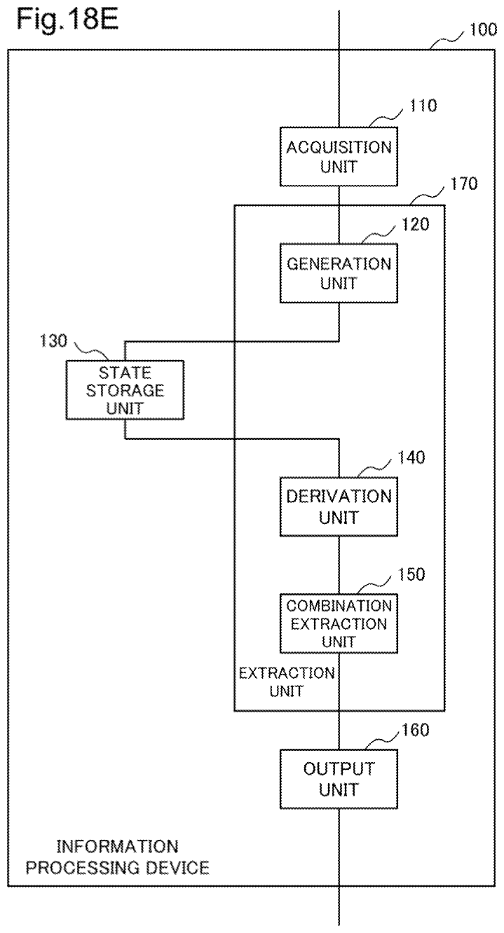

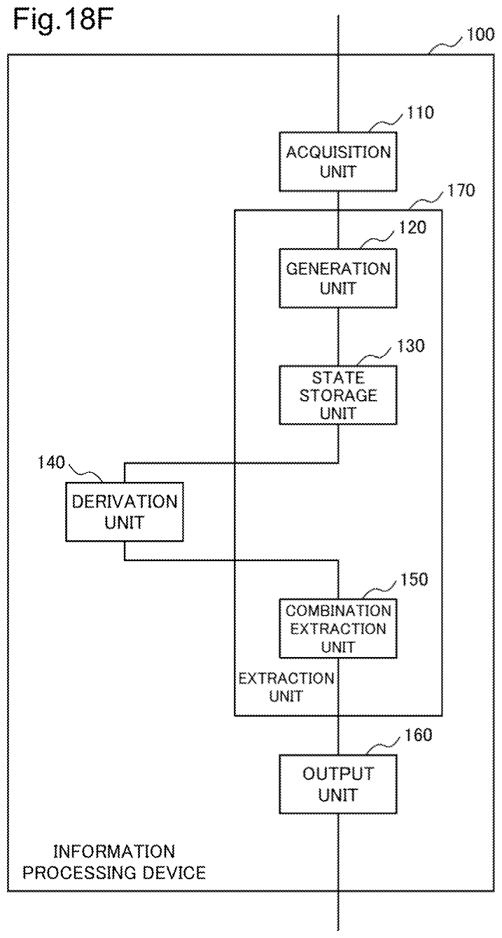

FIGS. 18A, 18B, 18C, 18D, 18E, and 18F are diagrams each illustrating a configuration of the information processing device 100 according to a third modification. In the third modification, the information processing device 100 includes the acquisition unit 110 and the extraction unit 170. The extraction unit 170 of the present modification includes the combination extraction unit 150. The extraction unit 170 further includes two of the generation unit 120, the state storage unit 130, the derivation unit 140, and the output unit 160. The information processing device 100 further includes two units not included in the extraction unit 170 among the generation unit 120, the state storage unit 130, the derivation unit 140, and the output unit 160.

In a case where the configuration of the information processing device 100 is the configuration illustrated in FIG. 18A (also referred to as a first aspect of the third modification), the extraction unit 170 operates as the derivation unit 140, the combination extraction unit 150, and the output unit 160. In a case where the configuration of the information processing device 100 is the configuration illustrated in FIG. 18B (also referred to as a second aspect of the third modification), the extraction unit 170 operates as the state storage unit 130, the combination extraction unit 150, and the output unit 160. In a case where the configuration of the information processing device 100 is the configuration illustrated in FIG. 18C (also referred to as a third aspect of the third modification), the extraction unit 170 operates as the state storage unit 130, the derivation unit 140, and the combination extraction unit 150. In a case where the configuration of the information processing device 100 is the configuration illustrated in FIG. 18D (also referred to as a fourth aspect of the third modification), the extraction unit 170 operates as the generation unit 120, the combination extraction unit 150, and the output unit 160. In a case where the configuration of the information processing device 100 is the configuration illustrated in FIG. 18E (also referred to as a fifth aspect of the third modification), the extraction unit 170 operates as the generation unit 120, the derivation unit 140, and the combination extraction unit 150. In a case where the configuration of the information processing device 100 is the configuration illustrated in FIG. 18F (also referred to as a sixth aspect of the third modification), the extraction unit 170 operates as the generation unit 120, the state storage unit 130, and the combination extraction unit 150.

(Fourth Modification)

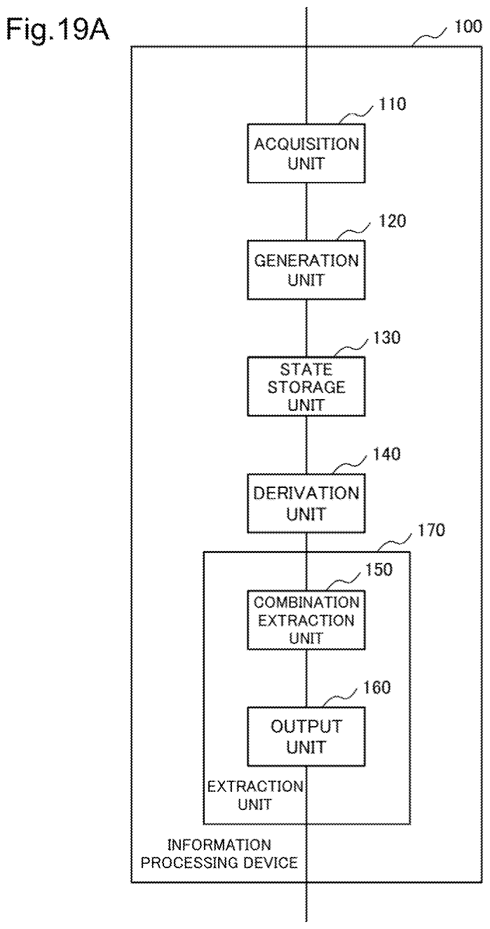

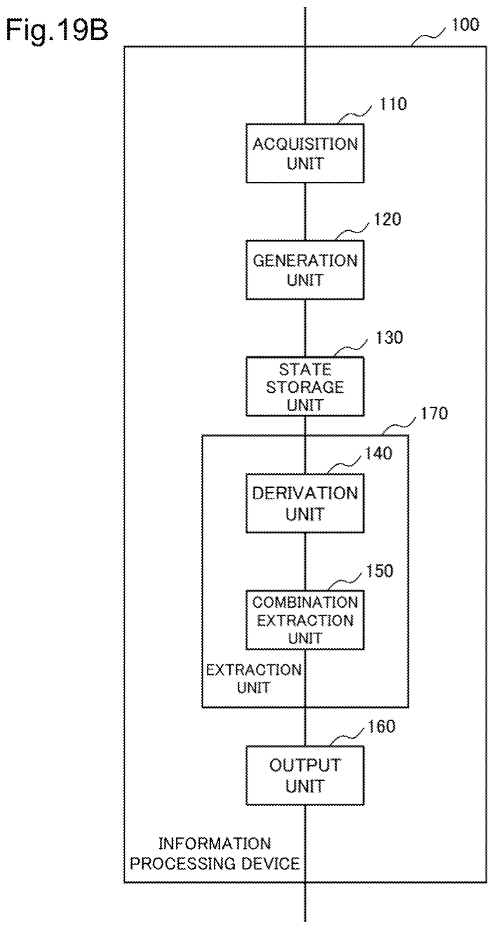

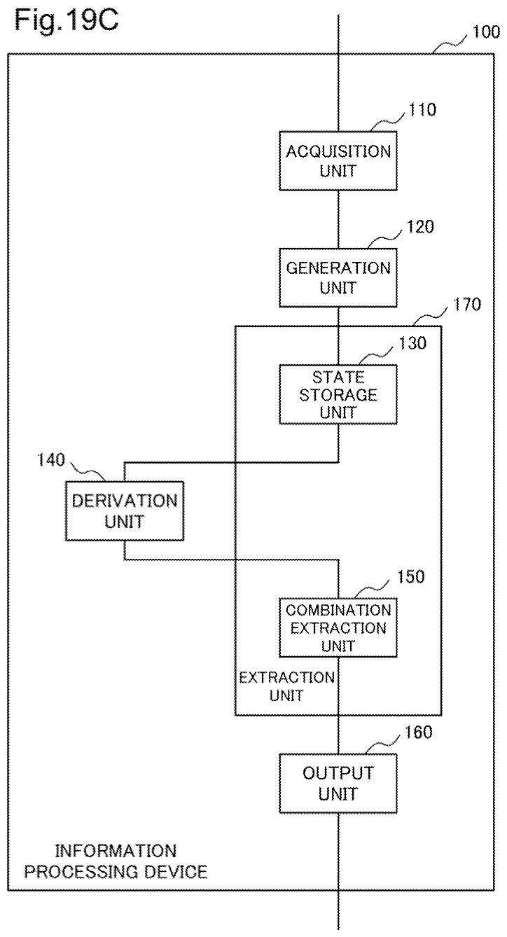

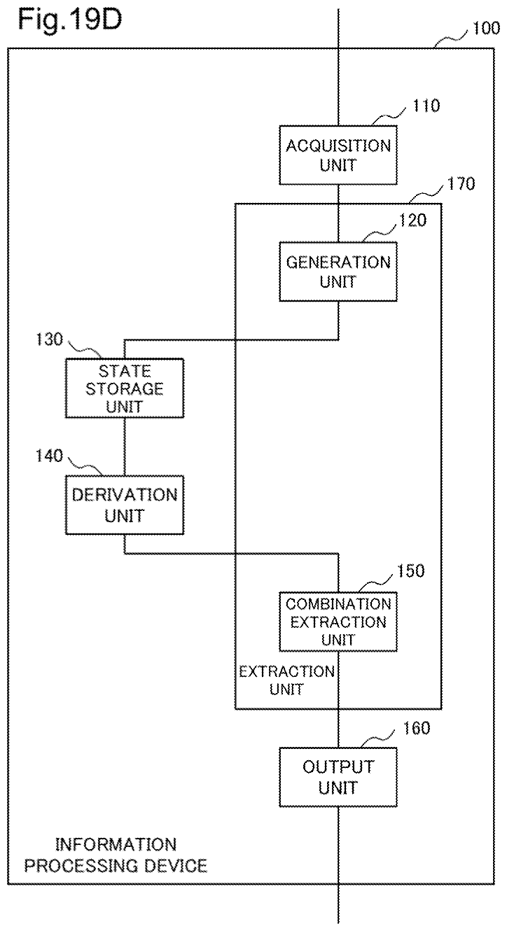

FIGS. 19A, 19B, 19C, and 19D are diagrams each illustrating a configuration of the information processing device 100 according to a fourth modification. In the fourth modification, the information processing device 100 includes the acquisition unit 110 and the extraction unit 170. The extraction unit 170 of the present modification includes the combination extraction unit 150. The extraction unit 170 further includes one of the generation unit 120, the state storage unit 130, the derivation unit 140, and the output unit 160. The information processing device 100 further includes three units not included in the extraction unit 170 among the generation unit 120, the state storage unit 130, the derivation unit 140, and the output unit 160.

In a case where the configuration of the information processing device 100 is the configuration illustrated in FIG. 19A (also referred to as a first aspect of the fourth modification), the extraction unit 170 operates as the combination extraction unit 150 and the output unit 160. In a case where the configuration of the information processing device 100 is the configuration illustrated in FIG. 19B (also referred to as a second aspect of the fourth modification), the extraction unit 170 operates as the derivation unit 140 and the combination extraction unit 150. In a case where the configuration of the information processing device 100 is the configuration illustrated in FIG. 19C (also referred to as a third aspect of the fourth modification), the extraction unit 170 operates as the state storage unit 130 and the combination extraction unit 150. In a case where the configuration of the information processing device 100 is the configuration illustrated in FIG. 19D (also referred to as a fourth aspect of the fourth modification), the extraction unit 170 operates as the generation unit 120 and the combination extraction unit 150.

(Fifth Modification)

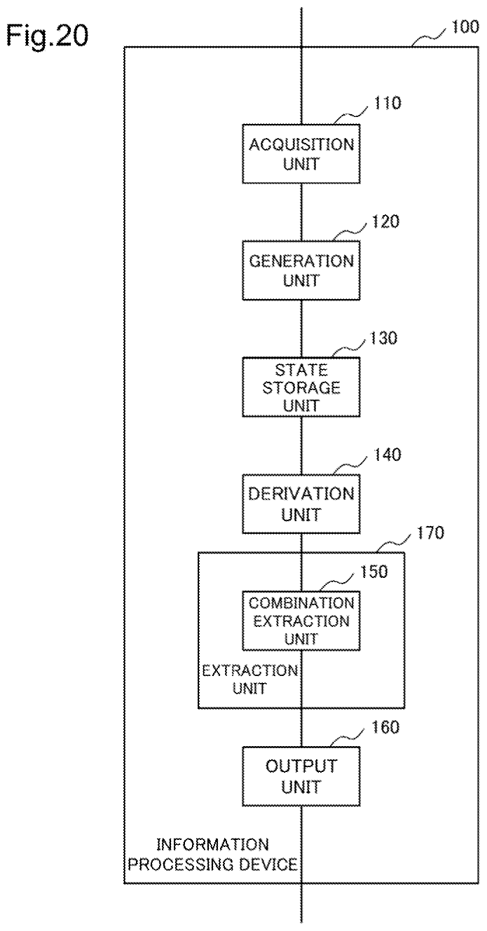

FIG. 20 is a diagram illustrating a configuration of the information processing device 100 according to a fifth modification. In the fifth modification, the information processing device 100 includes the acquisition unit 110 and the extraction unit 170. The extraction unit 170 of the present modification includes the combination extraction unit 150. The information processing device 100 further includes the generation unit 120, the state storage unit 130, the derivation unit 140, and the output unit 160.

In the fifth modification, the extraction unit 170 operates as the combination extraction unit 150.

(Sixth Modification)

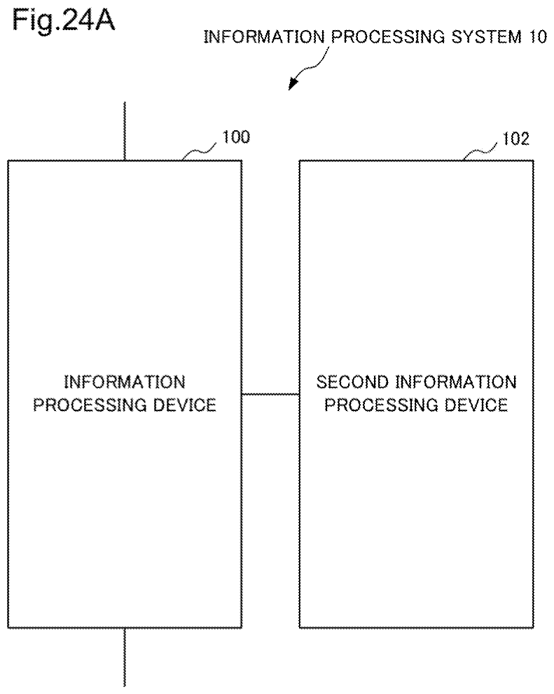

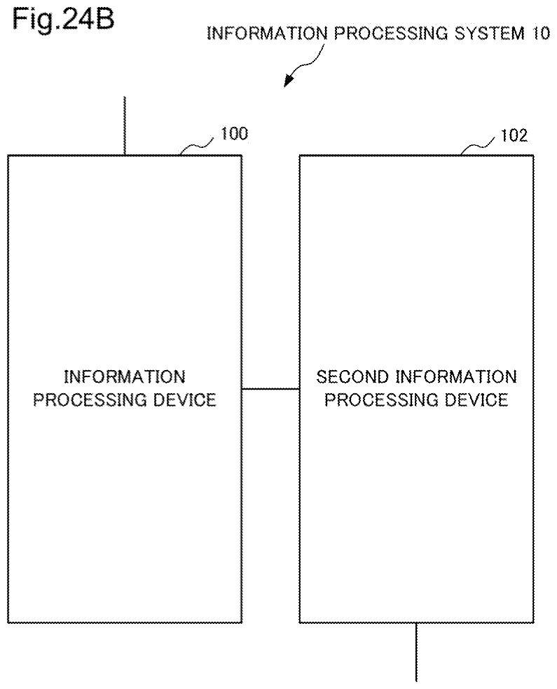

FIGS. 24A and 24B are diagrams each illustrating a configuration of an information processing system 10 according to sixth to fifteenth modifications. Specifically, FIG. 24A illustrates the configuration of the information processing system 10 according to the sixth to eleventh modifications and the thirteenth to fifteenth modifications in a case where the information processing device 100 includes the output unit 160. FIG. 24B illustrates the configuration of the information processing system 10 according to the sixth to eleventh modifications and the thirteenth to fifteenth modifications in a case where the second information processing device 102 includes the output unit 160. FIG. 24B illustrates a configuration of the information processing system 10 according to the twelfth modification.

In the sixth modification, the information processing system 10 includes the same function as the information processing device 100 of the first example embodiment. The information processing system 10 includes the information processing device 100 and the second information processing device 102. The information processing device 100 includes the acquisition unit 110 and the extraction unit 170. The extraction unit 170 of the present modification includes the combination extraction unit 150. The extraction unit 170 further includes three of the generation unit 120, the state storage unit 130, the derivation unit 140, and the output unit 160. The second information processing device 102 further includes one unit not included in the extraction unit 170 among the generation unit 120, the state storage unit 130, the derivation unit 140, and the output unit 160.

The extraction unit 170 of the present modification is similar to the extraction unit 170 of the second modification.

(Seventh Modification)

In the seventh modification, the information processing system 10 has the same function as the information processing device 100 of the first example embodiment. The information processing system 10 includes the information processing device 100 and the second information processing device 102. The information processing device 100 includes the acquisition unit 110 and the extraction unit 170. The extraction unit 170 of the present modification includes the combination extraction unit 150. The extraction unit 170 further includes two of the generation unit 120, the state storage unit 130, the derivation unit 140, and the output unit 160. The second information processing device 102 further includes two units not included in the extraction unit 170 among the generation unit 120, the state storage unit 130, the derivation unit 140, and the output unit 160.

The extraction unit 170 of the present modification is similar to the extraction unit 170 of the third modification.

(Eighth Modification)

In the eighth modification, the information processing system 10 has the same function as the information processing device 100 of the first example embodiment. The information processing system 10 includes the information processing device 100 and the second information processing device 102. The information processing device 100 includes the acquisition unit 110 and the extraction unit 170. The extraction unit 170 of the present modification includes the combination extraction unit 150. The extraction unit 170 further includes two of the generation unit 120, the state storage unit 130, the derivation unit 140, and the output unit 160. The second information processing device 102 includes one of two units not included in the extraction unit 170 among the generation unit 120, the state storage unit 130, the derivation unit 140, and the output unit 160. The information processing device 100 further includes one unit not included in the extraction unit 170 and the second information processing device 102 among the generation unit 120, the state storage unit 130, the derivation unit 140, and the output unit 160.

The extraction unit 170 of the present modification is similar to the extraction unit 170 of the third modification.

(Ninth Modification)

In the ninth modification, the information processing system 10 has the same function as the information processing device 100 of the first example embodiment. The information processing system 10 includes the information processing device 100 and the second information processing device 102. The information processing device 100 includes the acquisition unit 110 and the extraction unit 170. The extraction unit 170 of the present modification includes the combination extraction unit 150. The extraction unit 170 further includes one of the generation unit 120, the state storage unit 130, the derivation unit 140, and the output unit 160. The second information processing device 102 includes three units not included in the extraction unit 170 among the generation unit 120, the state storage unit 130, the derivation unit 140, and the output unit 160.

The extraction unit 170 of the present modification is similar to the extraction unit 170 of the fourth modification.

(Tenth Modification)

In the tenth modification, the information processing system 10 has the same function as the information processing device 100 of the first example embodiment. The information processing system 10 includes the information processing device 100 and the second information processing device 102. The information processing device 100 includes the acquisition unit 110 and the extraction unit 170. The extraction unit 170 of the present modification includes the combination extraction unit 150. The extraction unit 170 further includes one of the generation unit 120, the state storage unit 130, the derivation unit 140, and the output unit 160. The second information processing device 102 includes two of units not included in the extraction unit 170 among the generation unit 120, the state storage unit 130, the derivation unit 140, and the output unit 160. The information processing device 100 further includes one unit not included in the extraction unit 170 and the second information processing device 102 among the generation unit 120, the state storage unit 130, the derivation unit 140, and the output unit 160.

The extraction unit 170 of the present modification is similar to the extraction unit 170 of the fourth modification.

(Eleventh Modification)

In the eleventh modification, the information processing system 10 has the same function as the information processing device 100 of the first example embodiment. The information processing system 10 includes the information processing device 100 and the second information processing device 102. The information processing device 100 includes the acquisition unit 110 and the extraction unit 170. The extraction unit 170 of the present modification includes the combination extraction unit 150. The extraction unit 170 further includes one of the generation unit 120, the state storage unit 130, the derivation unit 140, and the output unit 160. The second information processing device 102 includes one of units not included in the extraction unit 170 among the generation unit 120, the state storage unit 130, the derivation unit 140, and the output unit 160. The information processing device 100 further includes two units not included in the extraction unit 170 and the second information processing device 102 among the generation unit 120, the state storage unit 130, the derivation unit 140, and the output unit 160.

The extraction unit 170 of the present modification is similar to the extraction unit 170 of the fourth modification.

(Twelfth Modification)

In the twelfth modification, the information processing system 10 has the same function as the information processing device 100 of the first example embodiment. The information processing system 10 includes the information processing device 100 and the second information processing device 102. The information processing device 100 includes the acquisition unit 110 and the extraction unit 170. The extraction unit 170 of the present modification includes the combination extraction unit 150. The second information processing device 102 includes the generation unit 120, the state storage unit 130, the derivation unit 140, and the output unit 160.

The extraction unit 170 of the present modification is similar to the extraction unit 170 of the fifth modification.

(Thirteenth Modification)

In the thirteenth modification, the information processing system 10 has the same function as the information processing device 100 of the first example embodiment. The information processing system 10 includes the information processing device 100 and the second information processing device 102. The information processing device 100 includes the acquisition unit 110 and the extraction unit 170. The extraction unit 170 of the present modification includes the combination extraction unit 150. The second information processing device 102 includes three of the generation unit 120, the state storage unit 130, the derivation unit 140, and the output unit 160. The information processing device 100 further includes one unit not included in the second information processing device 102 among the generation unit 120, the state storage unit 130, the derivation unit 140, and the output unit 160.

The extraction unit 170 of the present modification is similar to the extraction unit 170 of the fifth modification.

(Fourteenth Modification)

In the fourteenth modification, the information processing system 10 has the same function as the information processing device 100 of the first example embodiment. The information processing system 10 includes the information processing device 100 and the second information processing device 102. The information processing device 100 includes the acquisition unit 110 and the extraction unit 170. The extraction unit 170 of the present modification includes the combination extraction unit 150. The second information processing device 102 includes two of the generation unit 120, the state storage unit 130, the derivation unit 140, and the output unit 160. The information processing device 100 further includes two units not included in the second information processing device 102 among the generation unit 120, the state storage unit 130, the derivation unit 140, and the output unit 160.

The extraction unit 170 of the present modification is similar to the extraction unit 170 of the fifth modification.

(Fifteenth Modification)

In the fifteenth modification, the information processing system 10 has the same function as the information processing device 100 of the first example embodiment. The information processing system 10 includes the information processing device 100 and the second information processing device 102. The information processing device 100 includes the acquisition unit 110 and the extraction unit 170. The extraction unit 170 of the present modification includes the combination extraction unit 150. The second information processing device 102 includes one of the generation unit 120, the state storage unit 130, the derivation unit 140, and the output unit 160. The information processing device 100 further includes three units not included in the second information processing device 102 among the generation unit 120, the state storage unit 130, the derivation unit 140, and the output unit 160.

The extraction unit 170 of the present modification is similar to the extraction unit 170 of the fifth modification.

### Second Example Embodiment

Next, a second example embodiment of the present disclosure will be described.

«Configuration»

First, a configuration of an information processing device 101 according to the present example embodiment will be described in detail with reference to the drawings.

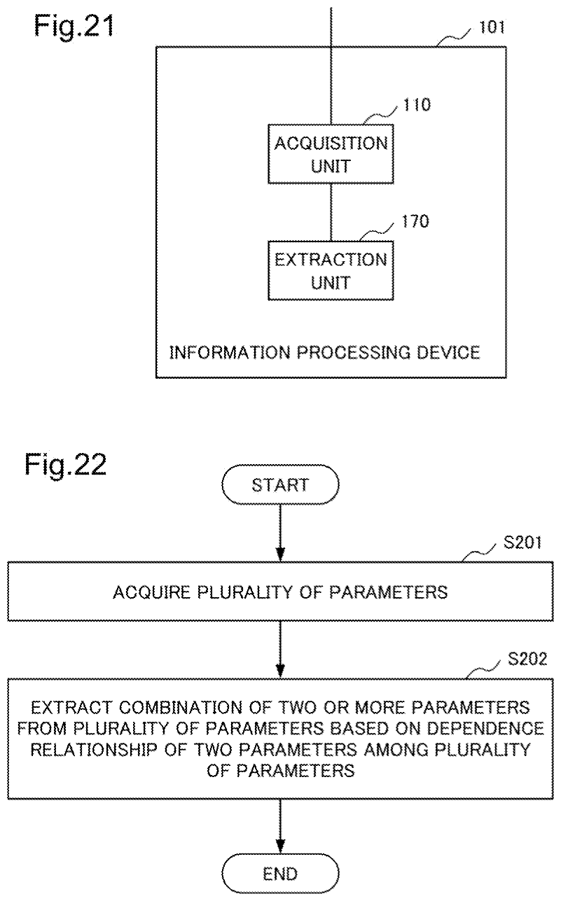

FIG. 21 is a block diagram illustrating an example of the configuration of the information processing device 101 according to the present example embodiment. In the example illustrated in FIG. 21, the information processing device 101 includes the acquisition unit 110 and the extraction unit 170. The acquisition unit 110 acquires a plurality of parameters indicating a device state. The extraction unit 170 extracts a combination including two or more parameters from the plurality of parameters based on a dependency relationship between a pair of two parameters among the plurality of parameters. The device may be a vehicle as in the first example embodiment. The device may be another device or facility such as a plant or a control system as described later as an application example. For example, the extraction unit 170 may extract a combination in which the magnitude of the dependency relationship between two parameters included in the extracted combination satisfies the predetermined standard. In a case where a combination including two or more parameters cannot be extracted from the plurality of parameters based on the dependency relationship between two parameters, the extraction unit 170 of the present example embodiment may not extract such a combination. For example, in a case where the number of parameters is two and the dependency relationship between the parameters does not satisfy the predetermined standard, the extraction unit 170 may not extract the combination of the parameters. The same applies to the combination extraction unit 150 and the extraction unit 170 of the first example embodiment in this respect.

«Operation»

Next, the operation of the information processing device 101 according to the present example embodiment will be described in detail with reference to the drawings.

FIG. 22 is a flowchart illustrating an example of the operation of the information processing device 101 according to the present example embodiment. In the example illustrated in FIG. 22, first, the acquisition unit 110 acquires a plurality of parameters (step S201). The acquisition unit 110 may acquire the plurality of parameters in the form of a plurality of data frames each including at least one of the plurality of parameters. The acquisition unit 110 may acquire a plurality of parameters, for example, as the device state of the first example embodiment. Next, the extraction unit 170 extracts a combination of two or more parameters from the plurality of parameters based on a dependency relationship between two parameters (that is, a pair of parameters) among the plurality of parameters (step S202). The extraction unit 170 may extract a closed combination of parameters as a combination of two or more parameters as in the first example embodiment.

«Effects»

The present example embodiment has the same effect as that of the first example embodiment. The reason is the same as the reason why the effect of the first example embodiment occurs.

### Other Application Examples

The first example embodiment is an example of a case where the device is a vehicle. The present example embodiment can also be applied to another system in which a controller which monitors a device state transmits a data frame including a parameter indicating the device state to a network. The present example embodiment can also be applied to, for example, a plant and a control system. In that case, the device may be a plant or a control system. The plant may be, for example, a chemical factory, an electronic device manufacturing factory, a plant factory, or the like.

In this case, the parameter may be, for example, a flow rate, a pressure, a flow velocity, a temperature, or a content rate or a content of a specific component of a fluid such as a liquid or a gas flowing through a pipe, a space, or the like. The parameter may be a humidity of the gas. The parameter may be a pressure, a temperature, or the like of the fluid in a container. The parameter may indicate a voltage value, a current value, a temperature, or the like of a current flowing through a cable. The parameter may be a usage amount of power, material, fuel, water, fertilizer, or the like. The parameter may be the number of people or the number of objects. The parameter may be an intensity of an electromagnetic wave or an intensity of a sound wave. The parameter may be a state of switches of a control panel. The parameter may be a set temperature of a cooling device or a heating device. The parameter may be an opening degree of a valve or the like. The parameter may be a product yield or a product production speed detected by an inspection device. The parameter may be an index indicating a state of growth of an agricultural product. The parameter may be another setting state or another measurement result. The parameter may be input to a terminal or the like by an operator, for example, and transmitted to a network by the terminal or the like.

### Other Example Embodiments

The information processing device according to the above-described example embodiment can be achieved by a computer including a processor that executes a program read from a storage medium and loaded into a memory. The information processing device according to the above-described example embodiment can also be achieved by a plurality of computers that are connected to each other and can communicate with each other. The information processing device according to the above-described example embodiment can also be achieved by one dedicated circuit or a plurality of circuits connected to communicate with each other. The information processing device according to the above-described example embodiment can also be achieved by a combination of the above-described computer and a dedicated circuit.

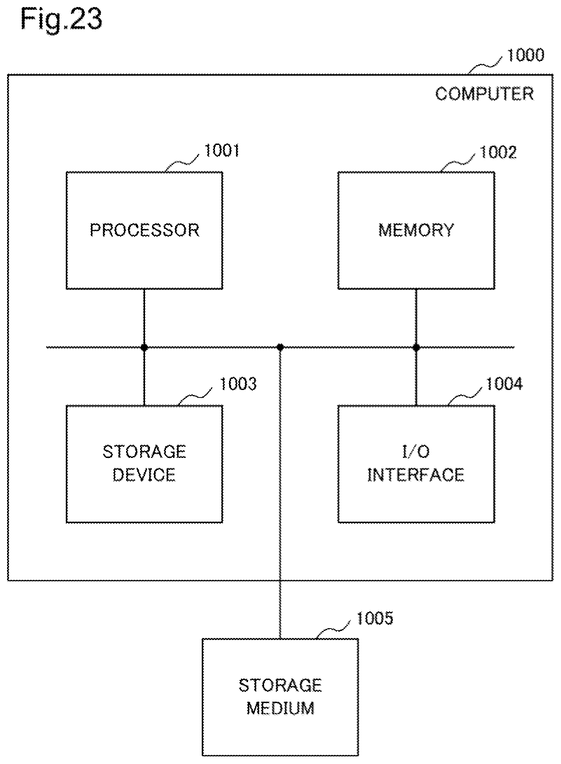

FIG. 23 is a block diagram illustrating an example of a hardware configuration of a computer 1000 that can achieve the information processing device according to the above-described example embodiment. In the example illustrated in FIG. 23, the computer 1000 includes a processor 1001, a memory 1002, a storage device 1003, and an input/output (I/O) interface 1004. In addition, the computer 1000 can access a storage medium 1005. The memory 1002 and the storage device 1003 are, for example, storage devices such as a random access memory (RAM) and a hard disk. The storage medium 1005 is, for example, a storage device such as a RAM or a hard disk, a read only memory (ROM), or a portable storage medium. The storage device 1003 may be the storage medium 1005. The processor 1001 can read and write data and programs from and in the memory 1002 and the storage device 1003. The processor 1001 can access, for example, the collection unit 300, the bus 400, and the like via the I/O interface 1004. The processor 1001 may access the storage medium 1005. The storage medium 1005 stores a program for operating the computer 1000 as the information processing device of the present example embodiment.

The processor 1001 loads a program, which is stored in the storage medium 1005 and causes the computer 1000 to operate as the information processing device 100, into the memory 1002. Then, the processor 1001 executes the program loaded in the memory 1002, whereby the computer 1000 operates as the information processing device 100.

The processor 1001 may load a program, which is stored in the storage medium 1005 and causes the computer 1000 to operate as the information processing device 101, into the memory 1002. Then, the processor 1001 executes the program loaded in the memory 1002, whereby the computer 1000 operates as the information processing device 101.

The acquisition unit 110, the generation unit 120, the derivation unit 140, the combination extraction unit 150, and the output unit 160 can be achieved by, for example, a storage device such as the memory 1002 and the processor 1001 that executes the program loaded in the memory 1002. The state storage unit 130 can be achieved by the memory 1002 or the storage device 1003 such as a hard disk device included in the computer 1000. Alternatively, some or all of the acquisition unit 110, the generation unit 120, the state storage unit 130, the derivation unit 140, the combination extraction unit 150, and the output unit 160 can be achieved by a dedicated circuit that implements the function of each unit.

Some or all of the above-described example embodiments may be described as the following supplementary notes, but are not limited to the following.

(Supplementary Note 1)

An information processing device including:

an acquiring means configured to acquire a plurality of parameters indicating a state of a device; and

an extracting means configured to extract a combination including two or more parameters from the plurality of parameters based on a dependency relationship between two parameters among the plurality of parameters.

(Supplementary Note 2)

The information processing device according to supplementary note 1, wherein

the extracting means extracts the combination in such a way that any magnitude of the dependency relationship between two parameters included in the combination satisfies a predetermined standard.

(Supplementary Note 3)

The information processing device according to supplementary note 1 or 2, wherein

the acquiring means receives values of the plurality of parameters as the plurality of parameters, the information processing device further including:

a deriving means configured to derive, as the dependency relationship, an index indicating a magnitude of interdependence of the two parameters based on the values.

(Supplementary Note 4)

The information processing device according to any one of supplementary notes 1 to 3, wherein

the extracting means extracts the combination based on a dependency relationship between changes of the two parameters.

(Supplementary Note 5)

The information processing device according to any one of supplementary notes 1 to 4, wherein

the acquiring means acquires a data frame which is transmitted from a controller included in the device and includes at least one parameter of the plurality of parameters, the information processing device further including:

a generating means configured to generate a state of the device based on the parameter included in the acquired data frame.

(Supplementary Note 6)

The information processing device according to any one of supplementary notes 1 to 5, wherein

the device is a vehicle, and

the plurality of parameters includes a parameter that takes a value based on a measurement value of the vehicle measured by a sensor mounted on the vehicle.

(Supplementary Note 7)

An information processing method including:

acquiring a plurality of parameters indicating a state of a device; and

extracting a combination including two or more parameters from the plurality of parameters based on a dependency relationship between two parameters among the plurality of parameters.

(Supplementary Note 8)

The information processing method according to supplementary note 7, wherein

the combination is extracted in such a way that any magnitude of the dependency relationship between two parameters included in the combination satisfies a predetermined standard.

(Supplementary Note 9)

The information processing method according to supplementary note 7 or 8, wherein

values of the plurality of parameters are received as the plurality of parameters, the method further including:

deriving, as the dependency relationship, an index indicating a magnitude of interdependence of the two parameters based on the values.

(Supplementary Note 10)

The information processing method according to any one of supplementary notes 7 to 9, wherein

the combination is extracted based on a dependency relationship between changes of the two parameters.

(Supplementary Note 11)

The information processing method according to any one of supplementary notes 7 to 10, wherein

a data frame is acquired which is transmitted from a controller included in the device and includes at least one parameter of the plurality of parameters, the method further including:

generating a state of the device based on the parameter included in the acquired data frame.

(Supplementary Note 12)

The information processing method according to any one of supplementary notes 7 to 11, wherein

the device is a vehicle, and

the plurality of parameters includes a parameter that takes a value based on a measurement value of the vehicle measured by a sensor mounted on the vehicle.

(Supplementary Note 13)

A storage medium storing a program for causing a computer to execute:

an acquisition process of acquiring a plurality of parameters indicating a state of a device; and

an extraction process of extracting a combination including two or more parameters from the plurality of parameters based on a dependency relationship between two parameters among the plurality of parameters.

(Supplementary Note 14)

The storage medium according to supplementary note 13, wherein

in the extraction process, the combination is extracted in such a way that any magnitude of the dependency relationship between two parameters included in the combination satisfies a predetermined standard.

(Supplementary Note 15)

The storage medium according to supplementary note 13 or 14, wherein

in the acquisition process, values of the plurality of parameters are received as the plurality of parameters, the medium storing the program for further causing the computer to execute:

a derivation process of deriving, as the dependency relationship, an index indicating a magnitude of interdependence of the two parameters based on the values.

(Supplementary Note 16)

The storage medium according to any one of supplementary notes 13 to 15, wherein

in the extraction process, the combination is extracted based on a dependency relationship between changes of the two parameters.

(Supplementary Note 17)

The information processing device according to any one of supplementary notes 13 to 16, wherein

in the acquisition process, a data frame is acquired which is transmitted from a controller included in the device and includes at least one parameter of the plurality of parameters, the information processing device storing the program for further causing the computer to execute:

a generation process of generating a state of the device based on the parameter included in the acquired data frame.

(Supplementary Note 18)

The storage medium according to any one of supplementary notes 13 to 17, wherein

the device is a vehicle, and

the plurality of parameters includes a parameter that takes a value based on a measurement value of the vehicle measured by a sensor mounted on the vehicle.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

1 network (in-vehicle network)
2 communication network
100 information processing device
101 information processing device
102 second information processing device
110 acquisition unit
120 generation unit
130 state storage unit
140 derivation unit
150 combination extraction unit
160 output unit
170 extraction unit
200 ECU
300 collection unit
400 bus
500 storage device
1000 computer
1001 processor
1002 memory
1003 storage device
1004 I/O interface
1005 storage medium

What is claimed is:

1. An information processing device comprising:
at least one memory configured to store instructions; and
at least one processor configured to execute the instructions to:
acquire a plurality of parameters indicating a state of a device; and
extract a combination including two or more parameters from the plurality of parameters based on a dependency relationship between two parameters among the plurality of parameters.

2. The information processing device according to claim 1, wherein
the at least one processor is further configured to execute the instructions to
extract the combination in such a way that any magnitude of the dependency relationship between two parameters included in the combination satisfies a predetermined criterion.

3. The information processing device according to claim 1, wherein
the at least one processor is further configured to execute the instructions to:
receive values of the plurality of parameters as the plurality of parameters; and
derive, as the dependency relationship, an index indicating a magnitude of interdependence of the two parameters based on the values.

4. The information processing device according to claim 1, wherein
the at least one processor is further configured to execute the instructions to
extract the combination based on a dependency relationship between changes of the two parameters.

5. The information processing device according to claim 1, wherein
the at least one processor is further configured to execute the instructions to:
acquire a data frame which is transmitted from a controller included in the device and includes at least one parameter of the plurality of parameters; and
generate a state of the device based on the parameter included in the acquired data frame.

6. The information processing device according to claim 1, wherein
the device is a vehicle, and
the plurality of parameters includes a parameter that takes a value based on a measurement value of the vehicle measured by a sensor mounted on the vehicle.

7. An information processing method comprising:
acquiring a plurality of parameters indicating a state of a device; and
extracting a combination including two or more parameters from the plurality of parameters based on a dependency relationship between two parameters among the plurality of parameters.

8. The information processing method according to claim 7, wherein
extracting the combination in such a way that any magnitude of the dependency relationship between two parameters included in the combination satisfies a predetermined criterion.

9. The information processing method according to claim 7, further comprising:
receiving values of the plurality of parameters as the plurality of parameters; and
deriving, as the dependency relationship, an index indicating a magnitude of interdependence of the two parameters based on the values.

10. The information processing method according to claim 7, further comprising
extracting the combination based on a dependency relationship between changes of the two parameters.

11. The information processing method according to claim 7, further comprising:
acquiring a data frame which is transmitted from a controller included in the device and includes at least one parameter of the plurality of parameters; and
generating a state of the device based on the parameter included in the acquired data frame.

12. The information processing method according to claim 7, wherein
the device is a vehicle, and
the plurality of parameters includes a parameter that takes a value based on a measurement value of the vehicle measured by a sensor mounted on the vehicle.

13. A non-transitory computer readable storage medium storing a program for causing a computer to execute:
acquisition processing of acquiring a plurality of parameters indicating a state of a device; and
extraction processing of extracting a combination including two or more parameters from the plurality of parameters based on a dependency relationship between two parameters among the plurality of parameters.

14. The storage medium according to claim 13, wherein
the extraction processing extracts the combination in such a way that any magnitude of the dependency relationship between two parameters included in the combination satisfies a predetermined criterion.

15. The storage medium according to claim 13, wherein
the acquisition process receiving values of the plurality of parameters as the plurality of parameters, and
the program further causes the computer to execute
derivation processing of deriving, as the dependency relationship, an index indicating a magnitude of interdependence of the two parameters based on the values.

16. The storage medium according to claim 13, wherein
the extraction process extracts the combination based on a dependency relationship between changes of the two parameters.

17. The information processing device according to claim 13, wherein
the acquisition process transmits a data frame is acquired which from a controller included in the device and includes at least one parameter of the plurality of parameters, and
the program further causes the computer to execute
generation processing of generating a state of the device based on the parameter included in the acquired data frame.

18. The storage medium according to claim 13, wherein
the device is a vehicle, and
the plurality of parameters includes a parameter that takes a value based on a measurement value of the vehicle measured by a sensor mounted on the vehicle.
